(19) United States
(12) Patent Application Publication
(10) Pub. No.: US 2022/0049503 A1
(43) Pub. Date: Feb. 17, 2022

(54) SYSTEMS AND METHODS FOR PRODUCING MAGNETICALLY RECEPTIVE LAYERS AND MAGNETIC LAYERS FOR USE IN SURFACE COVERING SYSTEMS

(71) Applicant: Golconda Holdings, LLC, Bay St. Louis, MS (US)

(72) Inventors: Shane S. Leblanc, Bay St. Louis, MS (US); Lloyd L. Lautzenhiser, Verdi, NV (US); Melinda Leblanc, Bay St. Louis, MS (US)

(21) Appl. No.: 17/310,128

(22) PCT Filed: Jan. 20, 2020
(86) PCT No.: PCT/US2020/014299

§ 371 Date: Jul. 19, 2021

Related U.S. Application Data
(63) Continuation-in-part of application No. 16/370,693, filed on Mar. 29, 2019, now abandoned.
(60) Provisional application No. 62/794,366, filed on Jan. 18, 2019.

(51) Int. Cl. E04F 13/08; E04F 13/18; B29D 7/00

(52) U.S. Cl. CPC E04F 13/0883; E04F 13/0866; E04F 2201/06; B29D 7/00; E04F 13/18

(57) ABSTRACT

A method for producing a surface covering system comprising magnetically receptive layers affixed to surface covering units and magnetized underlayments for use in securing surface covering units to supporting surfaces. The system includes isotropic magnetized floor covering units and anisotropic magnetized underlays for securing surface covering units. The system includes a set of formulations including ferrites and rare earth materials, oils and plasticizer and binding agents to optimize performance to meet design and application criteria.

### FIELD OF THE INVENTION

The present invention pertains to the art of surface coverings, and, more particularly to systems and methods for producing magnetically receptive layers and magnetic layers for use in surface covering systems for interior and exterior applications.

### BACKGROUND

In the field of modular floor covering unit installation, existing methods of installing such floor coverings typically involve a very labor and material intensive process. The process involves preparing a supporting surface, e.g., subfloor, and individually gluing down floor covering units using an adhesive. The adhesive is heavy, difficult to apply, costly, difficult to remove, and prone to failure. Additional problems include moisture migration, mold, cracking, etc. Using this prior art method, adhesive must be applied to the entire supporting surface or the entire underside of a floor covering unit. This process is costly in both labor and money and creates additional costs if floor covering units are to be replaced or removed. Another installation technique involves so-called floating floors that are susceptible to movement, buckling, and other issues.

Another method known in the art for installing modular floor covering units involves using adhesive connectors to connect modular floor covering units with adjacent units. Such “connector systems” of the prior art allow the modular floor covering to “float” on top of the supporting surface. These prior art systems use an adhesive to hold the edges of the adjacent flooring units together. One such system and method is the SYSTEM FOR CARPET TILE INSTALLATION, U.S. Pat. No. 8,434,282, issued May 7, 2013 (Scott et al.). The method described in Scott et al. utilizes a one-sided pressure sensitive adhesive tab that is approximately 72 mm square that has a releasable protective layer to join four sections of modular flooring units together. There a several problems with using this method to install a modular floor covering including the replacement of individual floor covering units, the difficulty of installation, and the durability of the installation method.

There also exist other carpet seaming methods for joining together two segments of floor covering material along long, straight seams. Such methods include CARPET SEAMING APPARATUS AND METHOD OF UTILIZING THE SAME, U.S. Pat. No. 5,800,664, issued Sep. 1, 1998 (Covert), and SEAMING APPARATUS AND METHOD, U.S. patent application Ser. No. 14/309,632, filed Jun. 19, 2014, (LeBlanc et al.). Additional methods exist for securing modular floor covering units together in a “floating floor” configuration that overcomes the problems and issues presented by the Scott et al. prior art. Such methods include MODULAR CARPET SEAMING APPARATUS AND METHOD, U.S. patent application Ser. No. 14/618,752, filed Feb. 10, 2015, (Lautzenhiser et al.).

Improvements have been made to these systems and methods for securing floor coverings including using magnetic underlayments with magnetically receptive layers secured or affixed to the floor covering units. In addition to floor covering applications, wall covering applications, ceiling covering applications, roof and exterior wall covering applications all have different environmental concerns and considerations that must be factored in determining suitable materials having suitable properties for installation and use. For example, exterior applications will involve exposure to sun, wind, rain, storm and other weather-related conditions. “Surface” covering applications is used to broadly refer to wall and floor covering applications unless indicated otherwise.

Magnetic systems are often anisotropic meaning they are direction dependent and may require both the surface covering component and the underlayment component to be arranged in a directional manner. Such purely anisotropic systems suffer from several drawbacks including the need to place and align the components in a defined manner adding to the complexity and cost of installation and materials. Isotropic materials are direction independent. Plastic binders may be used in manufacturing pliable, flexible magnetic sheets but this generally results in lower magnetic strength.

Examples of such systems and methods are described in at least U.S. patent application Ser. No. 16/013,902, entitled MODULAR MAGNETICALLY RECEPTIVE WOOD AND ENGINEERED WOOD SURFACE UNITS AND MAGNETIC BOX SYSTEM FOR COVERING FLOORS, WALLS, AND OTHER SURFACES, filed Jun. 20, 2018, Lautzenhiser et al.; U.S. patent application Ser. No. 15/083,255, entitled SYSTEM, METHOD, AND APPARATUS FOR MAGNETIC SURFACE COVERINGS, filed Mar. 28, 2016, Lautzenhiser et al.; in U.S. patent application Ser. No. 15/083,231, entitled SYSTEM, METHOD, AND APPARATUS FOR MAGNETIC SURFACE COVERINGS, filed Mar. 28, 2016, issuing as U.S. Pat. No. 10,189,236, on Jan. 29, 2019, Lautzenhiser et al.; and in U.S. Provisional Pat. App. 62/522,513, entitled MODULAR MAGNETIC WOOD AND ENGINEERED WOOD FLOORING UNITS UTILIZING A MAGNET BOX SYSTEM FOR FLOORS, WALLS, AND OTHER SURFACES, filed Jun. 20, 2017, LeBlanc et al.

However, with the existing systems and methods for installing floor and wall covering units, and the systems and methods for producing such installation systems, there exist issues when combining different material types and in producing the necessary system components. Existing systems may not be sufficiently dimensionally or structurally stable to be optimally suited for high traffic or use conditions, such as in commercial applications. The materials and production processes used to make existing floor/wall covering systems may not produce floor covering units and installation materials with the desired durability and stability required for commercial applications and long-term installation. Moreover, with existing systems, including existing magnetic floor covering systems, the receptive and magnetic layers may be too thick or heavy or have too weak a magnetic remanence for particular applications.

What is needed is a system and method for producing modular floor covering units that are compatible with a wide range of floor covering material and supporting surface types and compositions. Additionally, what is needed is a system and method for producing and installing modular floor covering units that are dimensionally and structurally stable, and are suitable light with at least a minimum magnetic remanence for particular installation applications.

Also what is needed is a system and method suitable for wall covering applications having suitable magnetic strength or holding strength to maintain positioning of a surface covering component relative to an underlying and supporting underlayment component adhered to a wall or other supporting structure.

Also what is needed is a system and method suitable for exterior wall covering applications having suitable magnetic strength or holding strength to maintain positioning of a surface covering component relative to an underlying and supporting underlayment component adhered to an exterior wall or other supporting structure. The magnetic strength or holding strength of the system must be capable of withstanding shear force associated with gravity as well as wind and other environmental conditions, e.g., hurricanes, tornados, falling debris, animals.

Also what is needed is a system and method suitable for exterior roof covering applications having suitable magnetic strength or holding strength to maintain positioning of a roof covering component relative to an underlying and supporting underlayment component adhered to an exterior roof or other supporting structure. The magnetic strength or holding strength of the system must be capable of withstanding shear force associated with gravity as well as wind and other environmental conditions, e.g., hurricanes, tornados, falling debris, animals.

Also what is needed is a system and method suitable for wall, floor and ceiling covering in airplane applications having suitable magnetic strength or holding strength to maintain positioning of a surface covering component relative to an underlying and supporting underlayment component adhered to a wall ceiling or other supporting structure. What is needed is a thin, light weight system specially adapted for use in airplanes having critical requirements to minimize weight and depth of installation.

Also what is needed is a method of manufacturing magnetic surface covering system components using rare earth materials and adapted to align crystalline structures to increase strength and limit thickness.

### SUMMARY OF INVENTION

The present invention provides a system, apparatus, and method for producing magnetically receptive layers and magnetic layers for use in surface covering systems. The present invention provides systems and methods for the manufacture of magnetically receptive layers and magnetic layers for use in surface covering systems that address issues with existing magnetic surface covering systems. The present invention comprises a two-component system comprising a magnetized underlay and an attracting floor covering unit.

The present invention provides a system and method for the production of magnetically receptive layers and magnetic underlayments as sheet goods for use in an interchangeable box system for attaching surface covering units to supporting surfaces. The magnetically receptive layers and magnetic underlayments of the present invention are better suited to installation in residential and commercial applications than the systems and methods disclosed in the prior art and provide benefits including increased durability, improved dimensional stability, and wider material compatibility than those used in known surface covering systems.

The materials, compounds, and processes used in the production of the magnetically receptive layers and magnetic underlayments of the present invention provide a significant improvement over the systems and methods of the prior art.

In a first embodiment, the present invention provides an isotropic magnetically receptive layer and an anisotropic magnetic underlayment. The magnetically receptive layer is disposed on the bottom or underside of a surface covering unit. The magnetic underlayment is disposed on a supporting surface. The anisotropic magnetic underlayment is substantially thinner than a similar isotropic magnetic underlayment but retains similar hold characteristics. For example, the anisotropic magnetic underlayment may be as much as 50% thinner while maintaining hold characteristics within 20% of an isotropic magnetic underlayment that is twice as thick.

In another embodiment, the present invention provides a “hybrid” magnetic underlayment. The “hybrid” magnetic underlayment comprises a blend of neodymium and ferrite powder. The “hybrid” magnetic underlayment may be dimensionally similar to a ferrite powder magnetic underlayment but may have a hold strength eight times greater than the ferrite powder magnetic underlayment. The “hybrid” magnetic underlayment may be suitable for applications where increased hold strength is required and where the increased cost associated with the neodymium powder is not a primary concern.

In another embodiment, the present invention provides a system and method for applying a magnetically receptive layer in a lower cost manner. A magnetically receptive ferrite powder blend may be mixed with a UV oil and sprayed onto a surface covering unit. The ferrite powder suspended in the UV oil is then set with high-powered UV lights. The hardened UV oil-ferrite powder blend acts as a magnetically receptive “B” side layer that is permanently bonded to the surface covering unit. Other oils or materials, such as PVC oil, may also be used.

The materials, compounds, and processes used in the production of the magnetically receptive layers and magnetic underlayments of the present invention provide a significant improvement over the systems and methods of the prior art.

In another embodiment, the present invention provides a system of surface covering components, the system when installed providing a quasi-permanent surface covering, the system comprising: a surface covering unit comprising an isotropic magnetically receptive layer; and an anisotropic magnetic underlayment disposed on a supporting surface.

The anisotropic magnetic underlayment may be 0.5 mm in thickness. The anisotropic magnetic underlayment may further comprise: a magnetizable material; a binder; and an oil. The magnetizable material may comprise one of: ferrous iron powder, strontium ferrite powder, neodymium powder, and a neodymium and ferrous iron composite. The binder may comprise thermoplastic chlorinated polyethylene elastomer (“CPE”). The oil may comprise epoxidized soybean oil (“ESBO”). The anisotropic magnetic underlayment may be a calendared sheet good. The anisotropic magnetic underlayment may further comprise a magnetizable material having a Mesh size of 1-2.3 μm.

In another embodiment, the present invention provides a magnetic underlayment layer for securing magnetically-receptive surface covering units on a supporting surface, the magnetic underlayment layer comprising: a neodymium powder; a binder; and an oil.

The magnetic underlayment layer may further comprise a plasticizer. The oil may comprise epoxidized soybean oil (“ESBO”). The ratio of the neodymium powder to the binder and the oil is less than 91% neodymium powder to 9% binder and oil. The magnetic underlayment layer may further comprise a ferrite powder. The ratio of the ferrite powder to the neodymium powder may be 50/50.

In another embodiment, the present invention provides a method for applying a magnetically receptive layer on a surface covering unit, the method comprising: adding a receptive material blend and an oil compound in a mixer; blending the receptive material blend and the oil compound to form a magnetically receptive oil blend; spraying the magnetically receptive oil blend onto a surface covering unit; and setting the magnetically receptive oil blend onto the surface covering unit.

The method may further comprise wherein the receptive material blend comprises one of: ferrous iron powder, strontium ferrite powder, neodymium powder, and a neodymium and ferrous iron powder composite. The method may further comprise wherein the oil compound comprises one of: ultraviolet (“UV”) oil, and polyvinyl chloride (“PVC”) resin. The setting of the magnetically receptive oil blend may further comprise setting the magnetically receptive oil blend by high intensity ultraviolet (“UV”) lights. The setting of the magnetically receptive oil blend may further comprise setting the magnetically receptive oil blend by high temperature.

In another embodiment, the present invention provides a method for producing a magnetically receptive sheet good for use in surface covering systems, the method comprising: combining a ferrite compound, a polymer, and a plasticizer in a mixing vessel; mixing the ferrite compound, the polymer, and the plasticizer at a desired mixing temperature and at a desired mixing pressure to form a magnetically receptive material; and extruding the magnetically receptive material at a desired extrusion temperature to form a magnetically receptive sheet good.

The method may further comprise annealing the magnetically receptive sheet good. The method may further comprise cold pressing the magnetically receptive sheet good onto a natural material building product. The method may further comprise hot pressing the magnetically receptive sheet good onto a synthetic material building product. The method may further comprise magnetizing the magnetically receptive sheet good. The composition of the magnetically receptive material may be selected from the group consisting of: pure iron powder (Fe) approximately 84%, chlorinated polyethylene elastomer polymer (CPE) approximately 15% and epoxidized soybean oil (ESBO) approximately 8%; Iron powder (Fe3O4) 90%, CPE 9% and plasticizer 1%; Mn—Zn (manganese/zinc) soft ferrite powder 90%, CPE 9% and plasticizer 1%; 20 portions of CPE, 150 portions of stainless iron powder; 30 portions of polyvinyl chloride, 18 portions of dioctyl terephthalate, 200 portions of stainless iron powder; or PVC 16.5%, calcium carbonate 39%, iron powder 26.5%, plasticizer 16%, and viscosity depressant & stabilizer 2%. The ferrite compound may be strontium ferrite, the polymer may be chlorinated polyethylene elastomer polymer (CPE), and the plasticizer may be epoxidized soybean oil (ESBO). The mixing may be performed for approximately 15 minutes, the desired mixing temperature may be under 120 degrees Celsius, and the desired mixing pressure may be atmospheric pressure. The desired extrusion temperature may be 120 degrees Celsius and wherein the magnetically receptive sheet good may be extruded at 10 meters per minute. The mixing may be performed for 20-30 minutes, the desired mixing temperature may be between 90-115 degrees Celsius, and the desired mixing pressure may be 0.4-0.7 MPa. The magnetically receptive sheet good may be extruded at 4-10 meters per minute and the desired extrusion temperature may be 40-70 degrees Celsius. The ferrite compound may be strontium ferrite having a particle size of 38-62 microns.

In another embodiment, the present invention provides a rust resistant and dimensionally stable magnetically receptive sheet good for use in surface covering systems, the sheet good comprising: a ferrite compound; a plasticizer; and a polymer. The sheet good may further comprise wherein the ferrite compound is strontium ferrite, the polymer is chlorinated polyethylene elastomer polymer (CPE), and the plasticizer is epoxidized soybean oil (ESBO). The sheet good may further comprise wherein the strontium ferrite comprises a particle size of 38-62 microns.

In another embodiment, the present invention provides a method for producing a magnetically receptive sheet good for use in surface covering systems, the method comprising: combining a ferrite compound, a polymer, and a plasticizer in a mixing vessel; mixing the ferrite compound, the polymer, and the plasticizer at a desired mixing temperature and at a desired mixing pressure to form a magnetically receptive material; and extruding the magnetically receptive material at a desired extrusion temperature to form a magnetically receptive sheet good; or applying a calendaring process to the magnetically receptive layer to form a magnetically receptive sheet good.

The method of the above embodiment may further comprise annealing the magnetically receptive sheet good. The method may further comprise cold pressing the magnetically receptive sheet good onto a natural material building product. The method may further comprise hot pressing the magnetically receptive sheet good onto a synthetic material building product. The method may further comprise magnetizing the magnetically receptive sheet good. The magnetically receptive layer may be magnetized to produce a magnetized underlayment adapted to magnetically engage and support a non-magnetized receptive layer component, the composition of the magnetically receptive material is selected from the group consisting of: for use in a calendaring process: 1) pure iron powder (Fe) or strontium ferrite approximately 89-91%, chlorinated polyethylene elastomer polymer (CPE) approximately 8-9% and epoxidized soybean oil (ESBO) approximately 1-2%; or 2) Iron powder (ferrous iron or ferrous ferric oxide, Fe3O4) approximately 89-91%, CPE approximately 8-9% and plasticizer approximately 1-2%; or for use in an extrusion process: 3) PVC approximately 16.5%, calcium carbonate approximately 39%, iron powder approximately 26.5%, plasticizer approximately 16%, and viscosity depressant & stabilizer approximately 2%. The magnetically receptive material may be used to produce a non-magnetized receptive component for use opposite a magnetized underlayment component, the composition of the magnetically receptive material is selected from the group consisting of: for use in a calendaring process: 1) Mn—Zn (manganese/zinc) soft ferrite powder approximately 89-91%, CPE approximately 8-9% and plasticizer approximately 1-2%; 2) approximately 20 portions of CPE, approximately 150 portions of stainless iron powder, approximately 30 portions of polyvinyl chloride (PVC), approximately 18 portions of dioctyl terephthalate, approximately 200 portions of stainless iron powder; or for use in an extrusion process: 3) PVC approximately 16.5%, calcium carbonate approximately 39%, plasticizer approximately 16%, viscosity depressant & stabilizer approximately 2%, and at approximately 26.5% one of: Mn—Zn (manganese/zinc) soft ferrite powder; stainless iron powder; or ferrous oxide or ferric oxide powder. The ferrite compound may be strontium ferrite, the polymer is chlorinated polyethylene elastomer polymer (CPE), and the plasticizer is epoxidized soybean oil (ESBO). The mixing may be performed for approximately 15 minutes, the desired mixing temperature may be under 120 degrees Celsius, and the desired mixing pressure is atmospheric pressure. The desired extrusion temperature may be 120 degrees Celsius and the magnetically receptive sheet good may be extruded at 10 meters per minute. The mixing may be performed for 20-30 minutes, the desired mixing temperature may be between 90-115 degrees Celsius, and the desired mixing pressure may be between 0.4-0.7 MPa. The magnetically receptive sheet good may be extruded at 4-10 meters per minute and the desired extrusion temperature is 40-70 degrees Celsius. The ferrite compound may be strontium ferrite having a particle size of 38-62 microns.

In another embodiment, the present invention provides a rust resistant and dimensionally stable magnetically receptive sheet good for use in surface covering systems, the sheet good being magnetized to provide a magnetized underlayment for magnetically engaging a non-magnetized receptive layer component, the magnetized underlayment comprising: for use in a calendaring process: 1) pure iron powder (Fe) or strontium ferrite approximately 89-91%, chlorinated polyethylene elastomer polymer (CPE) approximately 8-9% and epoxidized soybean oil (ESBO) approximately 1-2%; or 2) Iron powder (ferrous iron or ferrous ferric oxide, Fe3O4) approximately 89-91%, CPE approximately 8-9% and plasticizer approximately 1-2%; or for use in an extrusion process: 3) PVC approximately 16.5%, calcium carbonate approximately 39%, iron powder approximately 26.5%, plasticizer approximately 16%, and viscosity depressant & stabilizer approximately 2%. The ferrite component may comprise a particle size of 38-62 microns.

In another embodiment the present invention provides a rust resistant and dimensionally stable magnetically receptive component for use in surface covering systems, the magnetically receptive component being a non-magnetized receptive layer component for magnetically engaging with a magnetized underlayment, the magnetically receptive component comprising: for use in a calendaring process: 1) Mn—Zn (manganese/zinc) soft ferrite powder approximately 89-91%, CPE approximately 8-9% and plasticizer approximately 1-2%; 2) approximately 20 portions of CPE, approximately 150 portions of stainless iron powder, approximately 30 portions of polyvinyl chloride (PVC), approximately 18 portions of dioctyl terephthalate, approximately 200 portions of stainless iron powder; or for use in an extrusion process: 3) PVC approximately 16.5%, calcium carbonate approximately 39%, plasticizer approximately 16%, viscosity depressant & stabilizer approximately 2%, and at approximately 26.5% one of: Mn—Zn (manganese/zinc) soft ferrite powder; stainless iron powder; or ferrous oxide or ferric oxide powder.

In a first embodiment related to a further inventive aspect, the invention provides a surface covering system, the system when installed providing a removably-fixed surface covering, the system comprising: a magnetic surface covering unit comprising a non-magnetized, isotropic magnetic receptive layer; and an anisotropically magnetized underlayment disposed on a supporting surface; wherein the magnetic surface covering unit is adapted to be magnetically attracted to and received opposite the anisotropically magnetized underlayment in a fixed installation and to be non-destructively removable from the anisotropically magnetized underlayment subsequent to fixed installation. In addition, the invention may be further characterized by one or more of the following features: the anisotropically magnetized underlayment is 0.5 mm in thickness and comprises magnetizable material having a Mesh size configured to have, when magnetized, enhanced magnetic attraction property and adapted for supporting the magnetic surface covering unit in a non-horizontal fixed installation, wherein the non-horizontal fixed installation is one of an interior wall installation, an exterior wall installation, an airplane interior cabin installation, an exterior roof installation, or an interior ceiling installation. The invention may be further characterized by the anisotropically magnetized underlayment comprises: a magnetizable material including an iron powder; a binder component; and an oil having properties allowing for rapid setting during manufacturing, whereby setting occurs at a normal line speed in a calendaring or extrusion process. The invention may be further characterized by the magnetizable material comprises one of: ferrous iron powder, strontium ferrite powder, neodymium powder, and a neodymium and ferrous iron powder composite. The invention may be further characterized by: wherein the binder comprises thermoplastic chlorinated polyethylene elastomer (“CPE”); wherein the oil comprises epoxidized soybean oil (“ESBO”); wherein the anisotropically magnetized underlayment is one of a calendared sheet good or an extruded sheet good; wherein the anisotropically magnetized underlayment comprises a magnetizable material having a Mesh size of 1-2.3 μm.

In a second embodiment the present invention provides a magnetized underlayment for securing magnetically-receptive surface covering units on a supporting surface, the magnetized underlayment comprising: a neodymium powder; a binder; and an oil having properties allowing for rapid setting during manufacturing, whereby setting occurs at a normal line speed in a calendaring or extrusion process.

The invention may be further characterized by one or more of: the magnetized underlayment further comprising a plasticizer; wherein the oil comprises epoxidized soybean oil (“ESBO”); wherein the ratio of the neodymium powder to the binder and the oil is less than 91% neodymium powder to 9% binder and oil; wherein the magnetic underlayment layer further comprises a ferrite powder; wherein the ratio of the ferrite powder to the neodymium powder is 50/50. The invention may be further characterized by the ratio of the neodymium powder to the binder and the oil is selected based upon application considerations to be one of: about 91% neodymium powder to about 9% binder and oil; about 81% neodymium powder to about 19% binder and oil; about 71% neodymium powder to about 29% binder and oil; about 61% neodymium powder to about 39% binder and oil; or about 51% neodymium powder to about 49% binder and oil.

In a third embodiment the invention provides a method for applying a magnetically receptive layer on a surface covering unit to produce a magnetically receptive surface covering unit adapted to be magnetically secured opposite a magnetized underlayment, the method comprising: adding a receptive material blend and an oil compound in a mixer; blending the receptive material blend and the oil compound to form a magnetically receptive oil blend; spraying the magnetically receptive oil blend onto a surface covering unit; and setting the magnetically receptive oil blend onto the surface covering unit. The invention may be further characterized by one or more of: wherein the receptive material blend comprises one of: ferrous iron powder, strontium ferrite powder, and neodymium powder, and neodymium and ferrous iron powder composite; wherein the oil compound comprises one of: ultraviolet (“UV”) oil, and polyvinyl chloride (“PVC”) resin; wherein the setting of the magnetically receptive oil blend comprises rapidly setting the magnetically receptive oil blend by high intensity ultraviolet (“UV”) lights; wherein the setting of the magnetically receptive oil blend comprises setting the magnetically receptive oil blend by high temperature.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1 is a flowchart diagram of an embodiment of production process for a magnetized or magnetically receptive sheet good at atmospheric pressure.

FIG. 2 is a flowchart diagram of an embodiment of a production process for a magnetized or magnetically receptive sheet good at a pressure other than atmospheric pressure.

FIG. 3 is a flowchart diagram an embodiment of a production process for a magnetized or magnetically receptive material for use in a backing material layer.

FIG. 4 is an embodiment of a surface covering unit with an isotropic magnetic receptive layer and an anisotropic magnetic underlayment according to the present invention.

FIG. 5 is an embodiment of a surface covering unit with an isotropic magnetic receptive layer and a neodymium and ferrite powder blend “hybrid” magnetic underlayment according to the present invention.

FIG. 6 is a flowchart diagram of an embodiment of a production process for a magnetically receptive layer comprising a ferrite powder suspended in a hardened UV oil.

FIG. 7 is a simplified perspective diagram of a modular surface covering unit with a magnetically receptive layer and a magnetic underlayment disposed on a supporting surface.

FIG. 8 is a simplified perspective diagram of a modular surface covering unit with a magnetically receptive layer and a magnetic underlayment disposed on a supporting surface.

FIG. 9 is a simplified diagram of a system for manufacturing a calendared sheet good such as a magnetic or magnetically receptive sheet good according to one embodiment of the present invention.

### DETAILED DESCRIPTION

The present invention will now be described in more detail with reference to exemplary embodiments as shown in the accompanying drawings. While the present invention is described herein with reference to the exemplary embodiments, it should be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

Magnetized material produces a magnetic field that projects a force that pulls on or attracts ferromagnetic or ferrimagnetic materials, e.g., iron, ferrite, strontium ferrite, barium, nickel, cobalt, alloys of these and other materials such as rare-earth metals including neodymium-based materials. A magnetized component in a surface covering system may be made using a magnetic material that is then magnetized, such as by an external magnetic field applied to it, e.g., by passing under one or more strong permanent magnets or an electromagnet, so as to create a permanent or persistent magnetic field having remanence. Processes may be employed to apply a strong magnetic field during manufacture to alter the atomic structure and align internal microcrystalline structure resulting in greater remanence in the absence of an applied magnetic field. In particular, rare earth materials may be processed to align electrons to increase magnetic strength. Depending on the desired result, multiple stages of magnetization and magnetic alignment may be performed on a magnetic material. The magnetic strength of a magnetized material may be measured in terms of its magnetization (often denoted as M in A/m (amperes/meter) as a vector field), magnetic moment (often denoted as m or μ in A*m² as a vector) or magnetic field or flux or flux density (often denoted as B in teslas (T−weber/m²) as a vector field). Materials that may be magnetized are magnetically receptive and attracted to magnets prior to magnetization.

The strength of a magnet may be expressed in terms of its pull force, i.e., the magnet's ability to move or “pull” magnetically receptive objects. The pull force exerted by a permanent magnet is Maxwell's Equation expressed as:

$$F = {B}^{2} A / 2 {µ}_{0} \qquad Eq . 1$$

where F is force in newtons (SI); A is the cross-section of area in meters*squared; and B is the magnetic induction exerted by the magnetized material.

Relatedly, the Maxwell unit of measurement in the CGS (centimeter(cm)-gram-second) system is a unit of magnetic flux (Φ) (which is the integral of field over an area) and one Maxwell is the total flux across a surface of one square centimeter perpendicular to a magnetic field having a strength of one gauss, i.e., one Maxwell=one gauss×cm² ; and one Maxwell=10⁻⁸ weber (in the SI International System of Units). The gauss (G) is the CGS unit of measurement of magnetic flux density or magnetic induction (B) and one gauss=one 10⁻⁴ Tesla. Accordingly, units and expressions may be in either of CGS or SI and it is understood for purposes of this invention and the claims both apply equally.

One key consideration when considering effective use of magnetic surface covering systems is the applications, e.g., is the covering component being placed opposite an underlayment on a wall, a floor, a ceiling, a roof, a high-wind area, to meet building codes or classifications, etc. For instance, a magnet's holding strength required in the case of a vertical contact surface is very different than the holding strength required in the case of a horizontal contact surface. An interior horizontal contact surface application, i.e., the contact surface is horizontal or parallel to the ground or Earth, has essentially nil shear force operating against the system due to gravity. In contrast, a vertical application with the system perpendicular to ground has a significant shear force acting due to gravity creating potential for disengagement or slipping of the surface cover component against the underlayment, which may be fixed in some manner to the vertical wall or other surface. Accordingly, greater magnetic strength or pull is required given a vertical contact surface due to the weight of the covering component being placed and supported by the underlayment. In addition, in exterior conditions additional forces act on the system to place even greater burden on the system and increase the magnetic strength requirements to maintain system integrity.

System Component Receptive Material or “SCRM” refers to a material and/or composition for use manufacturing magnetically receptive layer products “MRLP” and underlayment products and may include, for example, a powder-based component or a sheet product, which may also be referred to as “Bulk Iron Material.” In one implementation, the SCRM in powder form may be directly pressed or otherwise applied to receptive layer components to arrive at a MRLP. In an alternative implementation, the SCRM may be used to make an intermediate sheet good for combining with finished surface cover components to arrive at MRLP products, in essence converting a non-magnetically receptive layer product, e.g., a wall or floor covering finished product, into an MRLP.

In one manner of implementing aspects of the present invention, modular surface covering units comprise a surface covering portion that may be, for example, a decorative floor or wall tile, a decorative wood plank, a decorative vinyl plank, or a carpet square. Other floor covering unit material types, shapes, and compositions may be used. The surface covering unit may a floor, wall or ceiling covering unit or may also be, for example, a trim or decorative piece other than a covering unit. In this manner, the floor or other covering unit may be used in a “interchangeable box system” wherein all covering units and decorative elements in the system may be easily installed, removed, moved, or rearranged on a magnetic underlayment disposed on a supporting surface (i.e., wall, floor, ceiling). Each modular surface covering unit also comprises a magnetically receptive layer. This magnetically receptive layer may be referred to as a “SCRM” layer or a “receptive ‘13’ side layer.” The SCRM layer (receptive “B” side layer) in the interchangeable box system takes on many different forms and processes depending upon the building material and the material composition of said building material.

In the present invention, each modular surface covering unit comprises a floor covering portion that may be, for example, a decorative floor tile, a decorative wood plank, a decorative vinyl plank, or a carpet square. Other floor covering unit material types, shapes, and compositions may be used. Additionally, the floor covering unit may instead be a wall or ceiling covering unit or may also be, for example, a trim or decorative piece other than a covering unit. In this manner, the floor or other covering unit may be used in a “interchangeable box system” or “magnetic box system” wherein all covering units and decorative elements in the system may be easily installed, removed, moved, or rearranged on a magnetic underlayment disposed on a supporting surface (i.e., wall, floor, ceiling). Each modular surface covering unit also comprises a magnetically receptive layer, which may be extruded onto the surface covering unit or may be a separate layer affixed to the unit. This magnetically receptive layer may be referred to as a system component receptive material (“SCRM”) layer or a “receptive ‘B’ side layer.” The SCRM layer (receptive “B” side layer) in the interchangeable box system takes on many different forms and processes depending upon the building material and the material composition of said building material.

### Isotropic Magnetically Receptive and Magnetic Layers:

The SCRM receptive layer of a covering unit, such as a modular floor covering unit, in the interchangeable box system may be adhered to organic compound materials such as natural wood or to natural stone or ceramic stone. The SCRM receptive layer may also be used with synthetic building materials such as luxury vinyl tiles “LVT”, luxury vinyl plank “LVP”, rubber compound products like sports surfaces and other similar surface coverings. Since the SCRM layer is used with different surface covering material compositions, it must comprise certain qualities for all applications. However, different materials and processes must be used to manufacture the SCRM layer when it is to be used with surface covering materials having “like” properties.

The interchangeable box system—magnetized underlayment, magnetically receptive layer, and surface covering unit (e.g., modular floor covering unit)—comprises unique properties and qualities that can be utilized to work with existing building materials. Additionally, other qualities are desired in the system to be compatible with a wider range of materials and in a wider range of applications. These additional qualities include, but are not limited to oxidation resistance, dimensional stability (i.e., will not grow or contract when exposed to outside/inside elements, for example changes in temperature or humidity), resistance to harsh chemicals and solvents (e.g., cleaning products), oils, heat, flammability, abrasion, rolling loads, heavy loads, vibration, foot traffic and the like. The elements of the interchangeable box system must also be receptive to the “A” side magnetized underlayment disposed on the supporting surface which must also comprise equal or similar properties.

In most SCRM applications, wherein the SCRM layer is joined to either natural, non-natural, or synthetic building materials, production of the SCRM layer comprises blending ferrous compounds with a desired polymer (e.g., Chlorinated Polyethylene “CPE”) to provide the SCRM layer with the desired properties described hereinabove. Additionally, a conditioning agent such as Epoxidized Soybean Oil “EPO” is used to achieve the desired flexibility and adherence during manufacture.

A ferrite is a type of ceramic compound composed of iron (III) oxide (Fe2O3) combined chemically with one or more additional metallic elements (e.g., iron oxide and strontium carbonate stainless iron powder, iron oxide 304 and other metallic compounds). Ferrite compounds are electrically nonconductive and ferrimagnetic, meaning they can be magnetized or attracted to a magnet. Ferrites can be divided into two families based on their magnetic coercivity and their resistance to being demagnetized. Hard ferrites have high coercivity and are difficult to demagnetize. They are used to make magnets, for example in devices such as refrigerator magnets, loudspeakers and small electric motors. Hard ferrites may be used in the production of the “A” side interchangeable box system magnetic underlayment. However, other compounds may be used in some applications for the magnetic underlayment where other properties are desired. Soft ferrites have low coercivity.

One embodiment of the interchangeable box system of the present invention uses a strontium ferrite compound having a hexagonal crystal structure at a 1.9-2.3 micron size for the “B” side receptive layer and the “A” side magnetic underlayment. However, the “A” side magnetic underlayment micron size may use an increased individual particle surface area to increase potential magnetization. An exemplary strontium ferrite compound may have the chemical structure SrFe12O19 SrO.6Fe2O3. Mesh size of the magnetic components as discussed below may be optimized based on application or other requirements.

Ferrites are produced by heating a mixture of finely-powdered precursors pressed into a mold. During the heating process, calcination of carbonates occurs in the following chemical reaction:

MCO3→MO+CO2

The oxides of barium and strontium are typically supplied as their carbonates, BaCO3 or SrCO3. The resulting mixture of oxides undergoes sintering. Sintering is a high temperature process similar to the firing of ceramic ware.

Afterwards, the cooled product is milled to particles smaller than 2 μm, small enough that each particle consists of a single magnetic domain. Next the powder is pressed into a shape, dried, and re-sintered. The shaping may be performed in an external magnetic field, in order to achieve a preferred orientation of the particles (anisotropy). This may be used to produce an anisotropic sheet good.

Small and geometrically easy shapes may be produced with dry pressing. However, in such a process small particles may agglomerate and lead to poorer magnetic properties compared to a wet pressing process. Direct calcination and sintering without re-milling is possible as well but leads to poor magnetic properties.

To allow efficient stacking of product in a furnace during sintering and to prevent parts sticking together, product may be separated using ceramic powder separator sheets. These sheets are available in various materials such as alumina, zirconia and magnesia. They are also available in fine, medium and coarse particle sizes. By matching the material and particle size to the product being sintered, surface damage and contamination can be reduced while maximizing furnace loading.

Chlorinated polyethylene elastomers (“CPE”) and resins have excellent physical and mechanical properties, such as resistance to oils, temperature, chemicals, and weather. CPE polymers, which may be referred to as “marine polymers”, may be used to provide a waterproof membrane or waterproofing characteristics to a sheet good produced for the interchangeable box system (e.g., the receptive “B” layer or the magnetized underlayment “A” layer). CPEs may also exhibit the characteristics of superior compression set resistance, flame retardancy, tensile strength and abrasion resistance and may provide these characteristics to the magnetic underlayment or magnetically receptive layer.

CPE polymers comprise may materials from rigid thermoplastics to flexible elastomers, making them highly versatile. CPE polymers are used in a variety of end-use applications such as wire and cable jacketing, roofing, automotive and industrial hose and tubing, molding and extrusion, and as a base polymer. In a preferred embodiment, a CPE polymer is the desired polymer in the magnetically receptive “B” and magnetic underlayment “A” side layers of the interchangeable box system of the present invention.

CPE polymers blend well with many types of plastics such as Polyethylene, EVA, and PVC which many building materials, such as Luxury Vinyl Plank and Tile Flooring Products, are comprised of Such blends of CPE polymers and other plastics can be formed into final products with adequate dimensional stability without the need of vulcanization. The excellent additive/filler acceptability characteristics of CPE polymers can provide a benefit in blends where compound performance and economics are critical such as in the production of the magnetically receptive “B” and magnetic underlayment “A” side layers of the interchangeable box system of the present invention.

Epoxidized soybean oil (ESBO) is a collection of organic compounds obtained from the epoxidation of soybean oil. It is used as a plasticizer and stabilizer in polyvinyl chloride (PVC) plastics. ESBO is a yellowish viscous liquid. ESBO is manufactured from soybean oil through the process of epoxidation. Polyunsaturated vegetable oils are widely used as precursors to epoxidized oil products because they have high numbers of carbon-carbon double bonds available for epoxidation. The epoxide group is more reactive than double bond and thus providing a more energetically favorable site for reaction and making the oil a good hydrochloric acid scavenger and plasticizer. Usually a peroxide or a peraclid is used to add an atom of oxygen and convert the —C═C— bond to an epoxide group.

Food products that are stored in glass jars are usually sealed with gaskets made from PVC. ESBO is typically one of the additives in the PVC gasket in that type of application. It serves as a plasticizer and as a scavenger for hydrochloric acid released when the PVC degrades thermally, e.g. when the food product undergoes sterilization.

Strontium ferrite, CPE polymers, and ESBO are used in making the magnetized underlayment “A” and magnetically receptive “B” side layers for the interchangeable box system of the present invention. The three compounds, strontium ferrite, CPE polymer, and ESBO, are used in various formula compositions and also provide unique properties that conventional methods of adherence of building materials simply do not have. Utilization of these compounds ensure that no volatile organic compounds “VOCs” are brought into building structures—a common problem of conventional adherence systems (e.g., glue down applications).

The interchangeable box system of the present invention may use one of the following formulas for the composition of the magnetized underlayment “A” and magnetically receptive “B” side layers. The specific formula chosen depends on the supporting surface, surface covering unit, environmental conditions, and use case for the interchangeable box system by the end user. The same formula or “bulk material” may be used for both layers, however, a strontium ferrite-based material is desirable for the underlayment layer and a ferrous iron-based material is desirable for the magnetically receptive “B” layer. The ferrous iron-based material is already at least partially oxidized providing a nearly rust proof layer. Additionally, a stainless iron mixture could be used in place of the ferrous iron-based material.

For both a strontium ferrite-based underlayment or a ferrous iron-based “B” layer, the layers start in a non-magnetized or receptive state. Strontium ferrite is more suitable for a magnetic underlayment as the strontium ferrite-based material performs better as a magnet than as a receptive layer compared to the ferrous iron-based material. Strontium ferrite is receptively weaker than ferrous iron. Ferrous iron (e.g., Fe2O3) is relatively more rust proof and magnetically receptive than strontium ferrite. A magnetic underlayment layer comprising a strontium ferrite-based material mixture would typically be approximately 1 mm thick. A magnetically receptive layer, such as a SCRM material layer, comprising a ferrous iron-based material mixture would typically be approximately 0.5 mm thick.

Magnetic or magnetically receptive sheet good material composition formulas include the following:

Pure iron powder (Fe) approximately 84%, CPE approximately 15% and soybean oil (ESBO) approximately 8%;

Iron powder (Fe3O4) 90%, CPE 9% and plasticizer 1% (C19H36O3 epoxy ester);

Mn—Zn (manganese/zinc) soft ferrite powder 90%, CPE 9% and plasticizer 1%;

20 portions of CPE, 150 portions of stainless iron powder; and

30 portions of PVC, 18 portions of DOTP, 200 portions of stainless iron powder. (Dioctyl terephthalate, commonly abbreviated DOTP or DEHT, is an organic compound with the formula C6H4 2. It is a non-phthalate plasticizer, being the diester of terephthalic acid and the branched-chain 2-ethylhexanol. This colorless viscous liquid may be used for softening PVC plastics).

These formulas are mixed and formed into a sheet good that is either “hot pressed” into or onto an existing building material, such as one comprised of synthetic materials. Natural materials (e.g., natural wood or natural stone) are “cold pressed” into natural materials as to not damage the natural material. The formulas provided above do not comprise the most receptive sheet good for a magnetization process. The formulas above each comprise a tradeoff to have the required strength to hold a building material in a fixed position on a plane (e.g., supporting surface such as a wall or floor), and have the desired qualities stated above.

Depending upon the nature of the existing building material onto which the magnetically receptive “B” layer or the magnetized underlayment “A” layer is to be disposed different compositions may be used and are not necessarily limited to one of the formulas provided above. However, the above formulas are the preferred formula for most building material compositions and installation applications. In addition, depending upon the material composition for the surface covering unit onto which the finished sheet good (e.g., magnetic underlayment or magnetically receptive layer) is to be applied, the formula for the sheet good may be changed. For example, the formula may comprise mixing different powders, plasticizers, and other materials for the composition of the sheet good used in the magnetic underlayment or magnetically receptive layer. Compounds that are not as receptively strong, but that have already been oxidized, such as ferrous oxide or stainless iron powder, are used so that the sheet good is highly resistant to rust.

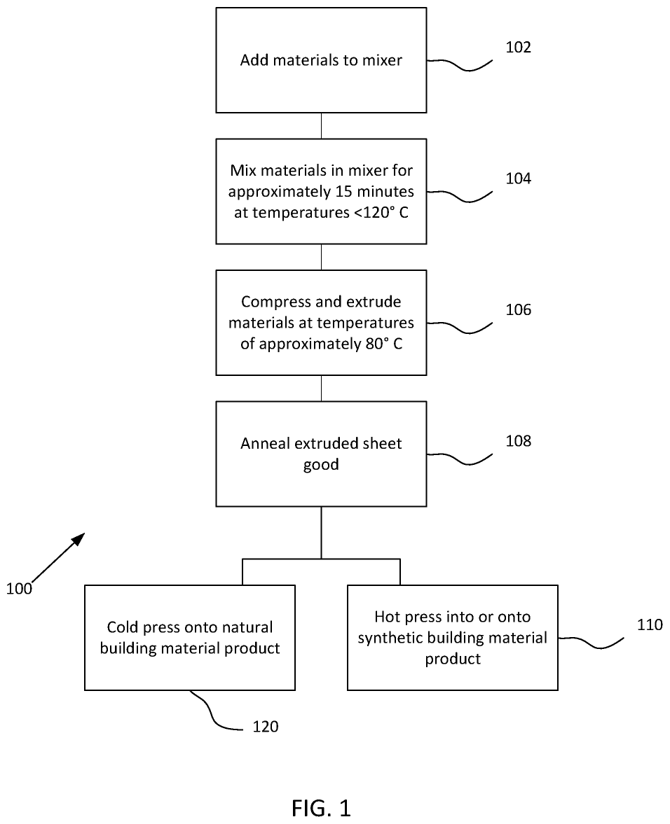

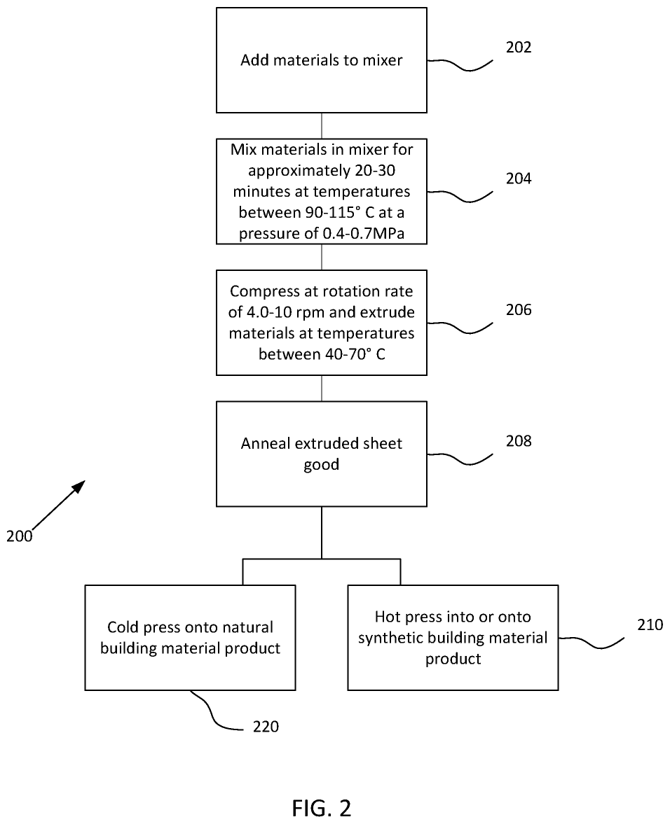

Exemplary processes for producing the sheet good for the magnetically receptive “B” layer or the magnetic underlayment “A” are provided in FIGS. 1 and 2. With reference first to FIG. 1, a process 100 for producing the sheet good at atmospheric pressure is provided. First, the components for producing the sheet good, such as strontium ferrite, CPE polymer, ESBO, according to the desired formula are placed in a mixer in step 102. Then in step 104, the materials are mixed and blended in a mixer, such as a banbury mixer, for approximately around 15 minutes at a maximum temperature is 120° C. The mixed materials are then compressed and extruded in step 106 as a sheet at a rate of approximately 10 m per minute at a temperature of approximately 80° C. In all steps of the process 100, the mixture is exposed to the air at atmospheric pressure and not in a vacuum or partial vacuum. An additional annealing process 408 may be performed after the mixture has been extruded as a sheet good. CPE polymers have properties that are better for dimensional stability than other possible materials but may still have dimensional stability issues. For formulas incorporating CPE polymers the step 108 of annealing will be used, but is not required in all sheet good formulas. In another embodiment, a CPE polymer having a higher melting point may be used. A blend or mixture using a higher melting point CPE polymer may require a different binder than a lower melting point CPE polymer. A blend using a high melting point CPE polymer may be mixed at approximately 190° C. and may also require higher temperatures at the extrusion and compression stages of forming the sheet good.

This vulcanizing/annealing step 108 is performed before the sheet good is applied to a building material to be used as the surface covering unit. A test of the sheet good may be performed at the lab level to determine the dimensional stability of the sheet good. For the sheet good to be used in securing a surface covering unit a desired level of dimensional stability is required. If the sheet good used as a magnetic underlayment “A” layer or magnetically receptive “B” layer is not dimensionally stable the surface covering unit may not stay installed as desired and the system may fail. For example, in the case of a flooring material, the flooring may have a catastrophic failure due to expansion and contraction and “warp” the building material causing or “peaks” or “gaps” which are not desirable and would lead and imperfect installation.

Annealing is a heat treatment that alters the physical and sometimes chemical properties of a material to increase its ductility and reduce its hardness. In annealing, atoms migrate in the crystal lattice and the number of dislocations decreases, leading to the change in ductility and hardness. This process makes it more workable. Annealing is used to bring a metal closer to its equilibrium state. In its heated, soft state, the uniform microstructure of a metal will allow for excellent ductility and workability. In order to perform a full anneal in ferrous metals the material must be heated above its upper critical temperature long enough to fully transform the microstructure to austenite. The metal must then be slow-cooled, usually by allowing it to cool in the furnace, so as to allow maximum ferrite and pearlite phase transformation.

Table 1 and Table 2, provided below illustrate the dimensional change, in the length direction in Table 1 and in the width direction in Table 2, of a sheet good after a 71 hour annealing process.

TABLE 1

| | Length Direction | | | |
|---|---|---|---|---|
| | Length | L. after | L. Change | L. Change |
| | (mm) | (mm) | (mm) | % |
| Receptive | 229.16 | 229.04 | −0.12 | −0.05 |
| Layer, | 209.71 | 209.51 | −0.20 | −0.10 |
| 55° C., | 189.44 | 189.22 | −0.22 | −0.12 |
| 71 hrs. | 129.47 | 129.35 | −0.12 | −0.09 |
| | 130.04 | 130.03 | −0.01 | −0.01 |
| | 128.29 | 128.29 | 0.00 | 0.00 |
| | 238.97 | 238.95 | −0.02 | −0.01 |
| | 238.84 | 238.60 | −0.24 | −0.10 |
| | 238.84 | 238.75 | −0.09 | −0.04 |
| | 3400.00 | 3400.00 | 0.00 | 0.00 |
| | 2158.00 | 2156.00 | −2.00 | −0.09 |
| Magnetic | 261.46 | 261.40 | −0.06 | −0.02 |
| Under- | 260.85 | 260.67 | −0.18 | −0.07 |
| layment, | 234.63 | 234.51 | −0.12 | −0.05 |
| 55° C., | 240.37 | 240.34 | −0.03 | −0.01 |
| 71 hrs. | 231.07 | 230.95 | −0.12 | −0.05 |
| | 2372.80 | 2370.00 | −2.80 | −0.12 |
| | 2366.00 | 2366.00 | 0.00 | 0.00 |

TABLE 2

| | Width Direction | | | |
|---|---|---|---|---|
| | Width | W. after | W. Change | W. Change |
| | (mm) | (mm) | (mm) | % |
| Receptive | 215.33 | 215.23 | −0.10 | −0.05 |
| Layer, | 239.95 | 239.88 | −0.07 | −0.03 |
| 55° C., | / | / | / | / |
| 71 hrs. | 110.99 | 110.95 | −0.04 | −0.04 |
| | 111.45 | 111.45 | 0.00 | 0.00 |
| | 113.13 | 113.11 | −0.02 | −0.02 |
| | 238.93 | 238.73 | −0.20 | −0.08 |
| | 239.59 | 239.52 | −0.07 | −0.0.3 |
| | 239.70 | 239.62 | −0.08 | −0.03 |
| | 915.10 | 915.00 | −0.10 | −0.01 |
| | 913.10 | 912.60 | −0.50 | −0.05 |
| Magnetic | 259.49 | 259.40 | −0.09 | −0.03 |
| Under- | 259.10 | 259.09 | −0.01 | 0.00 |
| layment, | 239.77 | 239.71 | −0.06 | −0.03 |
| 55° C., | 204.79 | 204.68 | −0.11 | −0.05 |
| 71 hrs. | 259.88 | 259.82 | −0.06 | −0.02 |
| | 791.90 | 790.70 | −1.20 | −0.15 |
| | 792.00 | 791.10 | −0.90 | −0.11 |

After the annealing step 108, or if the annealing step 108 is not required due to the formula composition used for the sheet good, the sheet good is then be hot pressed onto a synthetic building material product in step 110 or cold pressed into a natural building material product in step 120 to form a finished surface covering unit. If the sheet good is not to be used on a surface covering unit and is to be used as a magnetic underlayment, a magnetization step may be performed on the sheet good to form a magnetic underlayment “A” layer.

To magnetize the underlayment “A” layer a magnetic roller may be used. The magnetic roller comprises a plurality of north and south poles positioned very closely to one another on the roller. For thicker underlayments, where a large number of north/south poles are not required for achieving a desired magnetic remanence in the material, the north/south poles may be relatively spaced out on the roller. In this application, a roller comprising a plurality of magnetic washers compressed together on a rod or axle may be used. Exemplary systems are described in U.S. Pat. Pub. 2008/0278272, entitled SHEET MAGNETIZER SYSTEMS AND METHODS THEREOF, filed Apr. 15, 2008, Arnold; and in U.S. Pat. No. 7,728,706, entitled MATERIAL MAGNETIZER SYSTEMS, issued Jun. 1, 2010. Reducing the distance between the north and south poles on the roller provides for more north/south poles to be magnetized on the magnetic underlayment “A” layer, thereby producing a magnetic underlayment with a greater magnetic remanence. This is required for producing a thinner magnetic underlayment with the same or greater magnetic remanence than a thicker layer. To magnetize a thinner magnetic underlayment “A” layer with a roller, a solid roller must be used. The solid roller may be comprised of a ferrite material or of neodymium metal.

A solid magnetic roller comprises a plurality of north/south poles etched or engraved onto the roller. The etched or engraved roller is magnetized in a pulse magnetizer which may comprise a magnetic coil and an aligning field. The field in the pulse magnetizer may be configured to cause the particles in the roller to point in a particular direction. The etched roller may have etched and pulse-magnetized poles positioned between 1 and 2 mm apart, with closer poles being required for thinner magnetic underlayments. Another embodiment may employ a solid roller without any etching and wherein the underlayment layer to be magnetized comprises the etched north/south poles. This provides for even closer north/south poles than with an etched roller. The laser etching may be performed using prisms and gyro-moved laser diodes. The use of gyro-moved lasers maximizes the number of poles that can be transferred or etched onto a hot, compressed, underlayment layer.

With reference now to FIG. 2, a process 200 for producing a sheet good at non-atmospheric pressure is provided. First, the components for producing the sheet good, such as strontium ferrite, CPE polymer, ESBO, according to the desired formula are placed in a mixer in step 202. Then in step 204, the materials are mixed and blended in a mixer, such as a banbury mixer, for 20-30 minutes at a temperature of 90-115° C. and at a pressure of 0.4-0.7 MPa. In step 206 the sheet good is extruded at a compression rate into sheet form at a rotation rate of 4.0-10 meters per minute and at a temperature of 40-70° C. The mixture is compressed into a sheet good in step 206 by mutually compacting two rollers into a specified thickness which is typically 0.3 mm in thickness for a magnetically receptive “B” layer. An additional annealing process 208 may be performed after the mixture has been extruded as a sheet good. For formulas incorporating CPE polymers the step 208 of annealing will be used, but is not required in all sheet good formulas. After the annealing step 208, or if the annealing step 208 is not required due to the formula composition used for the sheet good, the sheet good is then be hot pressed onto a synthetic building material product in step 210 or cold pressed into a natural building material product in step 220 to form a finished surface covering unit. If the sheet good is not to be used on a surface covering unit and is to be used as a magnetic underlayment, a magnetization step may be performed on the sheet good to form a magnetic underlayment “A” layer.

For both the process 100 in FIG. 1 and the process 200 in FIG. 2, the micron size of the strontium ferrite compound is approximately 38-62 microns. This size is the preferred micron size in all formulae for the magnetic underlayment “A” layer and magnetically receptive “B” layer.

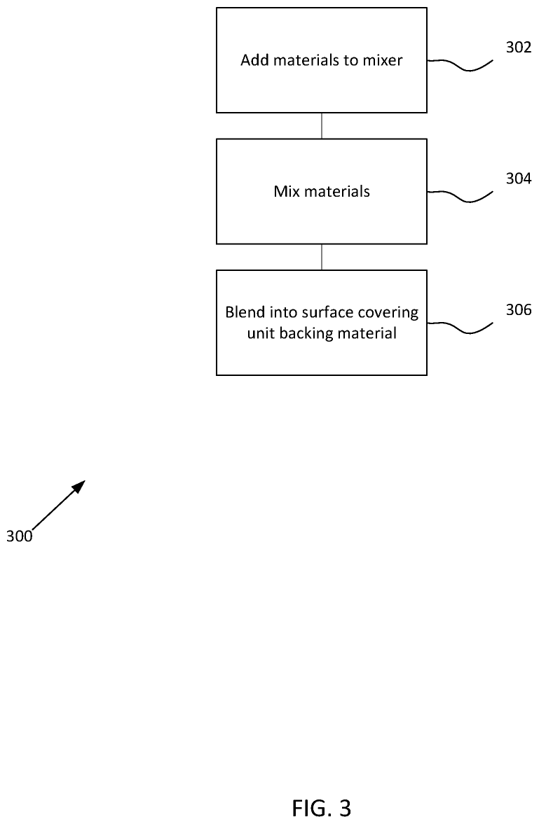

With reference now to FIG. 3, a process 300 for producing a magnetized or magnetically receptive material for use in a backing material layer is provided. For some building materials, such as with carpet tile, the magnetically receptive “B” layer of the interchangeable box system is not made into a sheet good, but is blended directly into the backing system that makes up a building material that uses like polymers. An example of one such formula that may be incorporated into a PVC backing carpet tile is 16.5% PVC, 39% calcium carbonate, 26.5% iron powder (Fe3O4), 16% plasticizer DOP (Bis2-Ethylhexyl Phthalate), or DINP (Diisononyl Phthalate), and 2% viscosity depressant & stabilizer. In this process, materials to produce the magnetized or magnetically receptive material for use in a backing material layer are introduced into a mixer in step 302. The materials are then mixed in a manner such as is described in step 104 in FIG. 1, or step 204 in FIG. 2. The mixed material is then blended into a backing of a surface covering unit in step 306 to produce a finished surface covering unit having a magnetized or magnetically receptive backing layer.

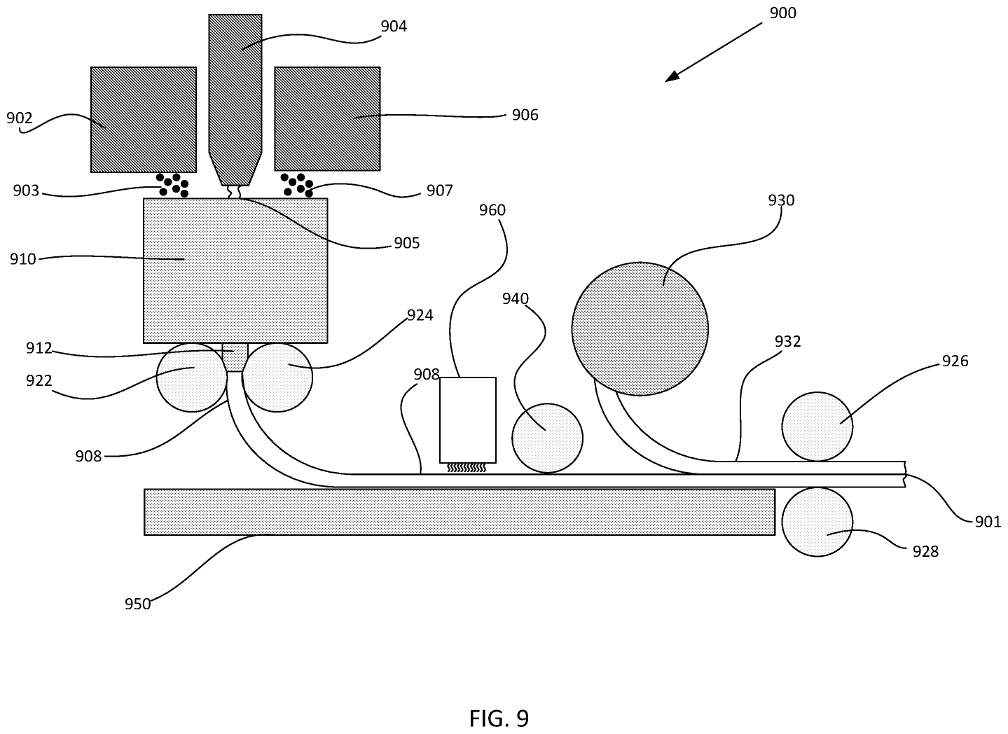

For the processes shown in FIG. 1, FIG. 2, and FIG. 3, a manufacturing system 900 such as is shown in FIG. 9 may be used. The manufacturing system 900 shown in FIG. 9 provides a system for producing either a magnetically receptive layer or a magnetized layer. Some elements of the system may be used for producing one type of sheet good while others may be not be used. In the exemplary embodiment shown in the system 900 in FIG. 9, the system 900 comprises material storage hoppers 902, 904, and 906, mixer 910, first set of rollers 922 and 924, conveyor 950, magnetizing roller 940, an annealing oven 960 and a second set of rollers 926. The materials 903, 905, and 907 stored in the respective storage hoppers 904, 906, and 908 may be, for example, a strontium ferrite blend, a CPE polymer, and ESBO, or may be more generally a magnetically receptive material blend, a binder or polymer, and a plasticizer. Other materials may be stored in other hoppers or storage tanks as necessary and as described herein. The materials 903, 905, and 907 are mixed in the mixer 910, which may be a banbury mixer, at a desired temperature and pressure for a specified period of time, and are then extruded through the nozzle 912 through the first set of rollers 922 and 924 into a calendared sheet good 908. Additional sets of rollers beyond the first set of rollers 922 and 924 may also be used. A conveyor 950 may the calendared sheet good 908 through an annealing oven 960 and through a magnetic roller 940. Where a magnetically receptive sheet good is being produced, the magnetic roller 940 will not be used. A pulse magnetizer or other magnetization method may be used in place of the magnetic roller 940. The annealing oven 960 may be any oven or heating source suitable for annealing the calendared sheet good 908. After the calendared sheet good 908 has been annealed and magnetized, a surface covering 932 may be unrolled from a roll 930 and either hot or cold pressed onto the calendared sheet good 908 by the second set of rollers 926 and 928 to form the finished surface covering 901. Where a magnetic underlayment is being produced this finishing step will not be performed. Other materials may also be pressed onto the calendared sheet good 908 other than a material unrolled from a roll 930. For example, a magnetically receptive layer calendared sheet good 908 may be cut-to-size and individually pressed onto surface covering units not suitable for being stored in a roll form.

In another embodiment, the present invention provides a method for producing a magnetically receptive sheet good for use in surface covering systems, the method comprising: combining a ferrite compound, a polymer, and a plasticizer in a mixing vessel; mixing the ferrite compound, the polymer, and the plasticizer at a desired mixing temperature and at a desired mixing pressure to form a magnetically receptive material; and extruding the magnetically receptive material at a desired extrusion temperature to form a magnetically receptive sheet good; or applying a calendaring process to the magnetically receptive layer to form a magnetically receptive sheet good.

The method of the above embodiment may further comprise annealing the magnetically receptive sheet good. The method may further comprise cold pressing the magnetically receptive sheet good onto a natural material building product. The method may further comprise hot pressing the magnetically receptive sheet good onto a synthetic material building product. The method may further comprise magnetizing the magnetically receptive sheet good. The magnetically receptive layer may be magnetized to produce a magnetized underlayment adapted to magnetically engage and support a non-magnetized receptive layer component, the composition of the magnetically receptive material is selected from the group consisting of: for use in a calendaring process: 1) pure iron powder (Fe) or strontium ferrite approximately 89-91%, chlorinated polyethylene elastomer polymer (CPE) approximately 8-9% and epoxidized soybean oil (ESBO) approximately 1-2%; or 2) Iron powder (ferrous iron or ferrous ferric oxide, Fe3O4) approximately 89-91%, CPE approximately 8-9% and plasticizer approximately 1-2%; or for use in an extrusion process: 3) PVC approximately 16.5%, calcium carbonate approximately 39%, iron powder approximately 26.5%, plasticizer approximately 16%, and viscosity depressant & stabilizer approximately 2%. The magnetically receptive material may be used to produce a non-magnetized receptive component for use opposite a magnetized underlayment component, the composition of the magnetically receptive material is selected from the group consisting of: for use in a calendaring process: 1) Mn—Zn (manganese/zinc) soft ferrite powder approximately 89-91%, CPE approximately 8-9% and plasticizer approximately 1-2%; 2) approximately 20 portions of CPE, approximately 150 portions of stainless iron powder, approximately 30 portions of polyvinyl chloride (PVC), approximately 18 portions of dioctyl terephthalate, approximately 200 portions of stainless iron powder; or for use in an extrusion process: 3) PVC approximately 16.5%, calcium carbonate approximately 39%, plasticizer approximately 16%, viscosity depressant & stabilizer approximately 2%, and at approximately 26.5% one of: Mn—Zn (manganese/zinc) soft ferrite powder; stainless iron powder; or ferrous oxide or ferric oxide powder. The ferrite compound may be strontium ferrite, the polymer is chlorinated polyethylene elastomer polymer (CPE), and the plasticizer is epoxidized soybean oil (ESBO). The mixing may be performed for approximately 15 minutes, the desired mixing temperature may be under 120 degrees Celsius, and the desired mixing pressure is atmospheric pressure. The desired extrusion temperature may be 120 degrees Celsius and the magnetically receptive sheet good may be extruded at 10 meters per minute. The mixing may be performed for 20-30 minutes, the desired mixing temperature may be between 90-115 degrees Celsius, and the desired mixing pressure may be between 0.4-0.7 MPa. The magnetically receptive sheet good may be extruded at 4-10 meters per minute and the desired extrusion temperature is 40-70 degrees Celsius. The ferrite compound may be strontium ferrite having a particle size of 38-62 microns.

In another embodiment, the present invention provides a rust resistant and dimensionally stable magnetically receptive sheet good for use in surface covering systems, the sheet good being magnetized to provide a magnetized underlayment for magnetically engaging a non-magnetized receptive layer component, the magnetized underlayment comprising: for use in a calendaring process: 1) pure iron powder (Fe) or strontium ferrite approximately 89-91%, chlorinated polyethylene elastomer polymer (CPE) approximately 8-9% and epoxidized soybean oil (ESBO) approximately 1-2%; or 2) Iron powder (ferrous iron or ferrous ferric oxide, Fe3O4) approximately 89-91%, CPE approximately 8-9% and plasticizer approximately 1-2%; or for use in an extrusion process: 3) PVC approximately 16.5%, calcium carbonate approximately 39%, iron powder approximately 26.5%, plasticizer approximately 16%, and viscosity depressant & stabilizer approximately 2%. The ferrite component may comprise a particle size of 38-62 microns.

In another embodiment the present invention provides a rust resistant and dimensionally stable magnetically receptive component for use in surface covering systems, the magnetically receptive component being a non-magnetized receptive layer component for magnetically engaging with a magnetized underlayment, the magnetically receptive component comprising: for use in a calendaring process: 1) Mn—Zn (manganese/zinc) soft ferrite powder approximately 89-91%, CPE approximately 8-9% and plasticizer approximately 1-2%; 2) approximately 20 portions of CPE, approximately 150 portions of stainless iron powder, approximately 30 portions of polyvinyl chloride (PVC), approximately 18 portions of dioctyl terephthalate, approximately 200 portions of stainless iron powder; or for use in an extrusion process: 3) PVC approximately 16.5%, calcium carbonate approximately 39%, plasticizer approximately 16%, viscosity depressant & stabilizer approximately 2%, and at approximately 26.5% one of: Mn—Zn (manganese/zinc) soft ferrite powder; stainless iron powder; or ferrous oxide or ferric oxide powder.

### Anisotropic Magnetic and Magnetically Receptive Layers:

The magnetic and magnetically receptive layers described above for use in the magnetic box system are isotropic or “non-directional.” For an isotropic magnetic layer, there is no aligning field used in the magnetization process. This means that the underlayment and receptive layers may be installed on a surface in a direction independent manner. In some implementations of the magnetic box system, an anisotropic magnetic or magnetically receptive sheet good is desired. In an anisotropic layer an aligning field is used in the magnetization process to align all particles in the magnetic underlayment “A” layer in the same direction. For example, a thinner sheet good with a stronger magnetic bond may be desirable in installations where weight, but not directionality of installation, is a concern.

Aviation, or installing surface covering units on the floors, fuselage interior, bulkheads, and other interior surfaces of an airplane, is one application that is particularly sensitive to the weight of materials used. The use of an anisotropic blend is desirable in an aviation application due to weight concerns on aircraft. A different material component blend is used for an anisotropic layer than is used with the isotropic magnetic and magnetically receptive layers described above, but a similar or greater magnetic strength using anisotropic powders is achieved. Additionally, the layer thickness for the anisotropic layer has been reduced from 1.0 mm to 0.5 mm compared to the ferrous iron or strontium ferrite isotropic layers. Reducing the thickness by at least 50% compared to the isotropic layers provides a weight savings of nearly the same amount in an anisotropic layer having a similar magnetic remanence.

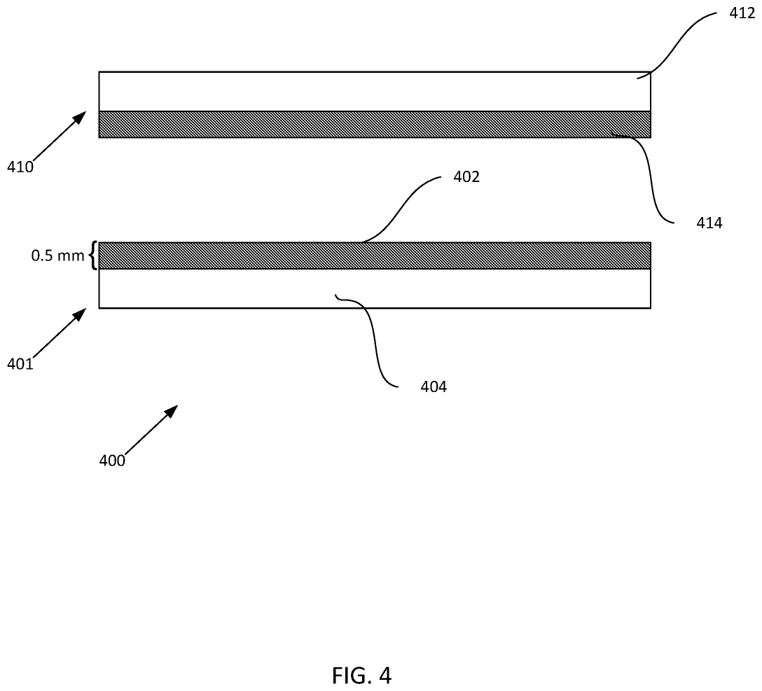

With reference to FIG. 4, an exemplary interchangeable box system 400 comprising an isotropic surface covering unit 410 and a supporting surface assembly 401 with an anisotropic magnetic underlayment 402 with a 0.5 mm thickness disposed on a supporting surface 404 according to the present invention is provided. The isotropic surface covering unit 410 comprises a decorative or top layer 412 and an isotropic magnetically receptive SCRM “B” side layer 414. The isotropic magnetically receptive layer 414 is magnetically attracted to the anisotropic magnetic underlayment 402 disposed on a supporting surface 404.

Existing isotropic underlayments may have a thickness of 1.52 mm. However, for both isotropic and anisotropic underlayments reducing the Mesh size, thereby lowering the micron size of the particles in the material blend used to produce the magnetic layer, increases the surface area of each individual particle. This produces a higher magnetic strength due to an increased surface area per particle because of the particular crystal structures of the smaller particles. This in turn provides for a reduced thickness and overall raw material use in the magnetic underlayment.

A reduced Mesh size for the raw materials used in producing the magnetically receptive layer and magnetized underlayment provides for thinner layers. For example, using a smaller Mesh size provides for a magnetic underlayment with a 1.0 mm thickness to be used on a horizontal plane supporting surface (e.g., floor coverings) and a 0.5 mm thickness on vertical plane supporting surfaces (e.g., wall coverings). The smaller Mesh size provides benefits to magnetically receptive layers and magnetic underlayments comprising blends of anisotropic and isotropic materials, only anisotropic materials, or only smaller Mesh size isotropic materials. The thickness of the magnetically receptive or magnetic underlayments are may be within +/−0.5 mm of the ideal layer thickness depending on the particular installation application for which the layer will be used and depending on how the layer will be installed or secured to a surface.

Properties for both an isotropic magnetic underlayment layer and an anisotropic magnetic underlayment layer having a Mesh size of 1-2.3 μm for one or more of ferrite powders, iron powders, and anisotropic powders are provided in Table 3 and Table 4, below.

TABLE 3
Isotropic Magnetic Underlayment

| Thickness | ~1.0 | mm |
|---|---|---|
| Hardness | Shore 52-56 | |
| Surface Magnetic Strength | >410 | Gauss |
| Pull Strength | >39 | g/cm² |

| | |
|---|---|
| Vertical and Horizonal | >12N |
| Sheer Strength | |

TABLE 4
Anisotropic Magnetic Underlayment

| Thickness | ~0.5 | mm |
|---|---|---|
| Hardness | Shore 52-56 | |
| Surface Magnetic Strength | >360 | Gauss |
| Pull Strength | >24 | g/cm² |

| | |
|---|---|
| Vertical and Horizonal | >9N |
| Sheer Strength | |

Although anisotropic means that the magnetic underlayment is “oriented” in one direction (whereas isotropic is not), the magnetically receptive material is isotropic. Using an anisotropic magnetic “A” layer and an isotropic magnetically receptive “B” layer and provides for the entire system to still be isotropic, or directionless, in nature (i.e., no fixed installation orientation for surface covering units having an isotropic magnetically receptive layer on an anisotropic magnetic underlayment layer). Two exemplary formulas for producing magnetic underlayment layers are provided in Table 5 and Table 6, below.

TABLE 5
Formula 1

| | |
|---|---|
| Ferrite powder (e.g., Fe3O4) | 87% |
| CPE (thermoplastic chlorinated | 12% |
| polyethylene elastomer, which is | |
| produced by chlorination of | |
| polyethylene) | |
| Epoxidized soybean oil (“ESBO”) | 0.8% |

TABLE 6
Formula 2

| | |
|---|---|
| Ferrite powder (e.g., Fe3O4) | 89% |
| CPE and PVC Blend | 9% |
| Plasticizer | 0.5% |
| ESBO | 1.5% |

In Formula 1, the ESBO is a collection of organic compounds obtained from the epoxidation of soybean oil. It is used as a plasticizer and stabilizer in polyvinyl chloride plastics. ESBO is a yellowish viscous liquid. For both formulas, the magnetic underlayment is calendared into a sheet good without the use of a fiberglass scrim layer. The mixture is first mixed and blended in a banbury mixer for 25-35 minutes, temperature: 120-135° C., pressure: 0.4-0.7 MPa. The sheet good is formed by compressing the mixture into a sheet at a rotation rate of 4.0-10 rpm at a temperature of 40-80° C. The mixture is compressed into sheet form by mutually compacting two rollers for the specified thickness and then is put into a series of shaping rollers to fine tune the exact thickness of the underlayment sheet to a desired thickness. A final UV (ultraviolet) oil coating may then be applied on a conveyor belt through a spray mist and baked to set under an Ultraviolet light. The UV oil is sensitive and reactive to the UV light. In this manner the coating has the desired benefit of setting very quickly (rapid set) and optimally sets at the normal manufacturing line speed, i.e., the operator does not have to slow the line speed to allow extended baking or heating for setting purposes. This rapid set feature can be included in either an extrusion process or a calendaring process and for use in setting a layer as an underlayment or in connection with fabricating surface covering components. In connection with underlayment fabrication, the sheet of magnetic underlayment is then rolled onto a spool and cut into the desired roll length.

In another embodiment, the present invention provides a system of surface covering components, the system when installed providing a quasi-permanent surface covering, the system comprising: a surface covering unit comprising an isotropic magnetically receptive layer; and an anisotropic magnetic underlayment disposed on a supporting surface.

The target thickness for an anisotropic magnetic underlayment may be 0.5 mm in thickness, e.g., in applications requiring low profile (thickness) and low weight such as interior surface covering for airplanes. The anisotropic magnetic underlayment may further comprise: a magnetizable material; a binder; and an oil. The magnetizable material may comprise one of: ferrous iron powder, strontium ferrite powder, neodymium powder, and a neodymium and ferrous iron composite. The binder may comprise thermoplastic chlorinated polyethylene elastomer (“CPE”). The oil may comprise epoxidized soybean oil (“ESBO”). The anisotropic magnetic underlayment may be a calendared sheet good. A desired thickness may be a function of composition of materials included in the extrusion or blending processes (such as a choice of the exemplary formulations set forth herein), extrusion spraying techniques, calendaring techniques, target weight, desired magnetic strength, magnetic receptivity or attraction of the intended surface component, wall vs. floor applications, and building code requirements, to name a few considerations. The anisotropic magnetic underlayment may further comprise a magnetizable material having a Mesh size of 1-2.3 μm.

### Neodymium Magnetic Layer:

In another embodiment, a magnetic underlayment may be produced using a blend of neodymium and ferrite powder. An approximately 50/50 blend of neodymium powder and ferrite powder can be used to produce an anisotropic and isotropic sheet for interior or exterior use (e.g., roofs and exterior finishing). This “hybrid” blend of neodymium powder and ferrite powder provides an average of eight times increase in potential magnetic hold over a ferrite powder but at an increased cost. A magnetic underlayment comprising a blend of neodymium and ferrite powder would be suitable for applications such as roofs, extra heavy cladding on exteriors, slab stone, where an increase magnetic remanence over ferrite powder would be required.

Neodymium is an element of the rare earth family of metals. It has the atomic symbol Nd, atomic number 60, and atomic weight 144.24 g/mol. Neodymium is not found naturally in metallic form or unmixed with other lanthanides, and it is usually refined for general use. Although neodymium is classed as a “rare earth”, it is no rarer than cobalt, nickel, and copper ore, and is widely distributed in the Earth's crust, but mostly mined in China. A “hybrid” magnetic underlayment “A” layer comprising a neodymium and ferrite powder blend can support a significantly greater hanging weight than a ferrite powder magnetic underlayment. The “hybrid” magnetic underlayment “A” layer comprising a neodymium and ferrite powder blend is well suited for use as a complete roofing underlayment capable of withstanding hurricane or tornado force winds. Additionally, it may be used as the fastening system for glass solar panels reducing the cost of installing solar panels as a significant portion of the expense in installing solar panels is the fastening system and labor to install them.

Neodymium powder blends and “hybrid” magnetic underlayment are also suited to installation applications where weight is a concern. Because a “hybrid” magnetic underlayment has a relatively stronger pull than a ferrous iron or strontium ferrite blended underlayment, a thinner layer may be used to achieve the same pull strength. This may be desirable in installation applications in aircraft and in vehicles where the weight of the material may be a concern.

The blend of neodymium with other materials in the “hybrid” magnetic underlayment may be from 50-90% neodymium powder. For example, a composition having 91% neodymium-based material in an underlayment having a thickness of 0.5 mm will provide on the order of a 20-fold improvement in magnetic attraction or strength over a 1 mm thick underlayment using non-neodymium ferrite materials. However, increasing the percentage of neodymium powder in the blend is undesirable as it may lead to cracking or crumbling of “hybrid” magnetic underlayment as in insufficient percentage of binding material will be present. Accordingly, the invention provides alternative formulations to balance performance characteristics against application requirements. For example, for every 10% decrease in neodymium concentrations, i.e., 91% to 81% to 71%, etc., there is a corresponding drop in magnetic strength on the order of 2×, i.e., at 81% the underlayment will be 18-fold stronger that a 1 mm non-neodymium-based underlayment, at 71% the underlayment will be 16-fold stronger that a 1 mm non-neodymium-based underlayment, at 61% the underlayment will be 14-fold stronger that a 1 mm non-neodymium-based underlayment, etc. Accordingly, the ratio of the neodymium powder to the binder, the oil, and/or other materials may be selected based upon application considerations to be one of: about 91% neodymium powder to about 9% binder and oil; about 81% neodymium powder to about 19% binder and oil; about 71% neodymium powder to about 29% binder and oil; about 61% neodymium powder to about 39% binder and oil; or about 51% neodymium powder to about 49% binder and oil. The techniques described herein minimize the issue of cracking or brittleness associated with use of neodymium-based materials.

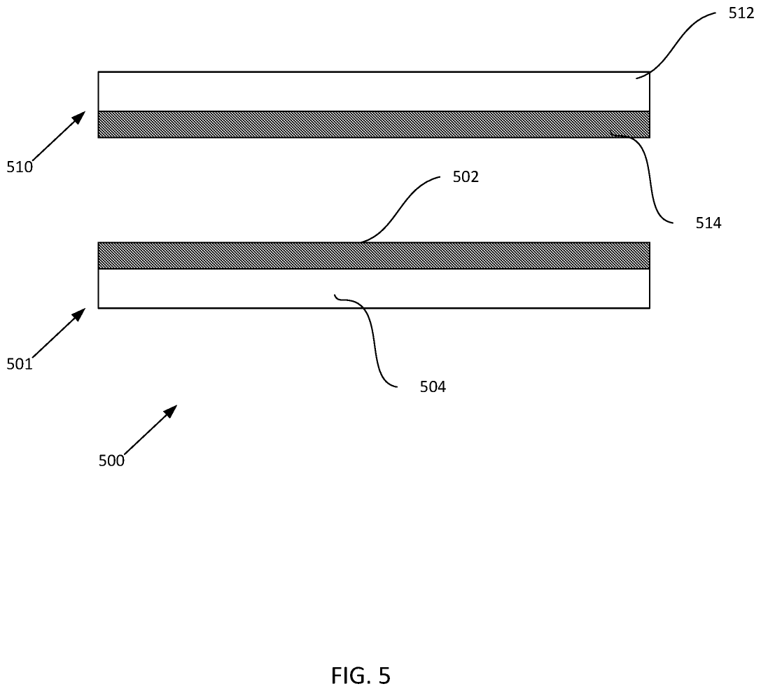

With reference to FIG. 5, an exemplary interchangeable box system 500 comprising a surface covering unit 510 and a supporting surface assembly 501 with a neodymium and ferrite blend “hybrid” magnetic underlayment 502 disposed on a supporting surface 504 according to the present invention is provided. The surface covering unit 510 comprises a decorative or top layer 512 and a magnetically receptive SCRM “B” side layer 514. The magnetically receptive layer 514 is magnetically attracted to the neodymium and ferrite blend “hybrid” magnetic underlayment 502 disposed on a supporting surface 504.

In another embodiment, the present invention provides a magnetic underlayment layer for securing magnetically-receptive surface covering units on a supporting surface, the magnetic underlayment layer comprising: a neodymium powder; a binder; and an oil.

The magnetic underlayment layer may further comprise a plasticizer. The oil may comprise epoxidized soybean oil (“ESBO”). The ratio of the neodymium powder to the binder and the oil is less than 91% neodymium powder to 9% binder and oil. The magnetic underlayment layer may further comprise a ferrite powder. The ratio of the ferrite powder to the neodymium powder may be 50/50.

### Ultraviolet Cured Oil-Based Magnetic and Magnetically Receptive Layers:

As described hereinabove, the magnetically receptive, or SCRM layer, is the “B” side layer of the Interchangeable Box System (IBS). The SCRM layer may take the form of a sheet good that is applied as the last layer in a building material, for example, the raw materials that comprise the sheet good may be calendared and then hot pressed, or cold pressed with resin glues as the last layer of a building material. In another embodiment, the materials that comprise the SCRM “B” layer may be applied to a surface covering using oils and polymer-based resin/glues and infused with ferrite powders.

However, these existing methods for applying the SCRM “B” side magnetically receptive layer to a surface covering may be cost or weight prohibitive for certain applications. The SCRM layer may be applied to a surface covering while reducing cost and thickness to meet this need using ultraviolet (“UV”) oil. UV oil is a material commonly used by surface covering unit manufacturers as a final protective layer for the surface covering. For example, a surface covering unit may comprise a wear layer (i.e., a scratch resistant coating) that is put on the surface covering unit as a top layer as a finish spray. The UV oil is sprayed on to the top layer of the flooring/wall unit by a set of nozzles. The sprayed surface covering unit is then carried away on the assembly belt and is subjected to ultra-high intensity UV lights that bake the UV oil to set it and permanently bond the UV oil spray application to the top layer as a wear layer.

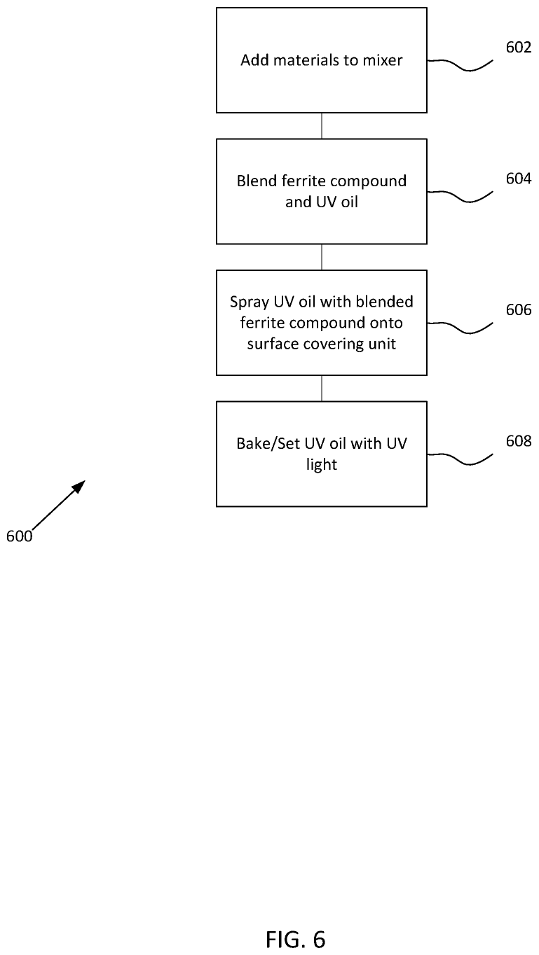

With reference to FIG. 6, a flowchart of a process 600 for producing a UV oil-based magnetically receptive layer is provided. At step 602, the ferrite powder and/or SCRM material blend of the present invention and a UV oil are added to a mixer. In step 604 the ferrite powder and/or SCRM material blend of the present invention and the UV oil are mixed together. In step 606, the blended mixture of the ferrite powder and/or SCRM material blend and UV oil are sprayed onto the last or bottom layer of the surface covering unit utilizing the same industrial process used to produce the wear layer. The surface covering unit with the ferrite infused UV oil is then carried on the assembly belt to the ultra-high intensity UV lights in step 608 where the UV oil is permanently bonded/baked onto the bottom of the surface covering unit as a completed SCRM “B” side magnetically receptive layer. The UV oil magnetically receptive layer may be less than 0.15 mm in thickness, which is thinner than the thinnest possible calendared or extruded magnetically receptive sheet good.

A PVC based resin may also be used in place of the UV oil. For example, the ferrite powder or SCRM material blend may be mixed into the PVC resin, which is then sprayed on and then baked in a line oven at a high temperature on the assembly belt to bond the ferrite powder infused PVC resin onto the bottom of the surface covering unit as a completed SCRM “B” side magnetically receptive layer. The temperature required to set the PVC resin depends on the type of PVC resin used.

Other polymers, resins, oils, other suitable liquids, and other suitable semi-solid material may be sprayed onto a surface covering unit to form a SCRM layer with an acceptable hold/sheer strength. The UV oil sprayed coating does not have to be as thick as the rolled sheet good layer and may be 0.1 mm instead of 0.3-0.5 mm thick. The hold strength of a UV oil sprayed on SCRM layer is lower than that of a magnetically receptive sheet good but still sufficient to secure the surface covering unit in place. The substantially reduced cost of spraying on a UV oil based SCRM “B” side magnetically receptive layer provides for the SCRM layer to be built into every surface covering unit whether the surface covering unit is to be installed in a glue down or magnetically secured installation.

In another embodiment, the present invention provides a method for applying a magnetically receptive layer on a surface covering unit, the method comprising: adding a receptive material blend and an oil compound in a mixer; blending the receptive material blend and the oil compound to form a magnetically receptive oil blend; spraying the magnetically receptive oil blend onto a surface covering unit; and setting the magnetically receptive oil blend onto the surface covering unit.

The method may further comprise wherein the receptive material blend comprises one of: ferrous iron powder, strontium ferrite powder, neodymium powder, and a neodymium and ferrous iron powder composite. The method may further comprise wherein the oil compound comprises one of: ultraviolet (“UV”) oil, and polyvinyl chloride (“PVC”) resin. The setting of the magnetically receptive oil blend may further comprise setting the magnetically receptive oil blend by high intensity ultraviolet (“UV”) lights. The setting of the magnetically receptive oil blend may further comprise setting the magnetically receptive oil blend by high temperature.

### Magnetic Box System:

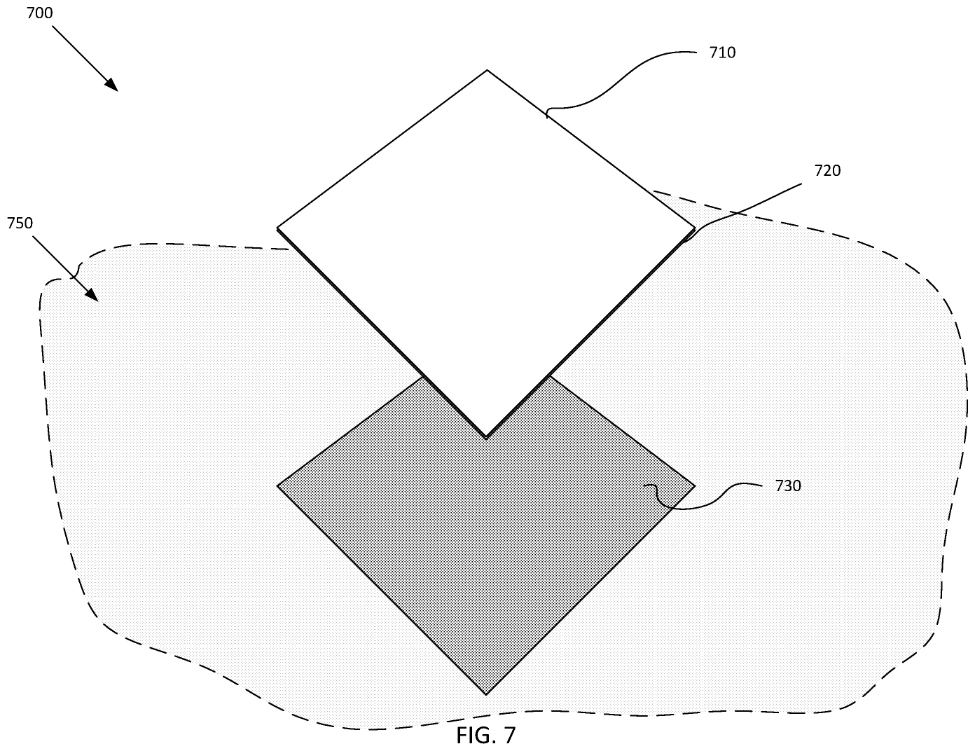

With reference now to FIG. 7, a simplified perspective diagram of a surface covering assembly 700 of a modular surface covering unit 710 with a magnetically receptive layer 720 and a magnetic underlayment 730 disposed on a supporting surface 750 is provided. The modular surface covering unit 710 may be, for example, a floor covering unit such as a LVT, stone tile, or a carpet tile. In another embodiment, the surface covering unit 710 may be a rolled wallpaper or other wall covering with a magnetically receptive layer 720 disposed on one side. In a wall covering unit, such as a wallpaper, the magnetically receptive layer may be glued on or otherwise adhered to the back or reverse side of the wall covering unit. With the LVT floor covering unit, the magnetically receptive layer 720 would be hot pressed onto the LVT. For a stone tile, the magnetically receptive layer 720 would be cold pressed onto the stone tile as it is a natural material. For the carpet tile, the magnetically receptive layer 720 may be blended into the carpet backing. The magnetic underlayment layer 730 is disposed on a supporting surface 750 which may be a wall, floor, ceiling, or a movable supporting surface such as a trade show display, but may also be any other suitable supporting surface. The magnetically receptive layer 720 of the surface covering unit 710 is magnetically attracted to the magnetic underlayment layer 730 and secures the surface covering unit 710 to the supporting surface 750.

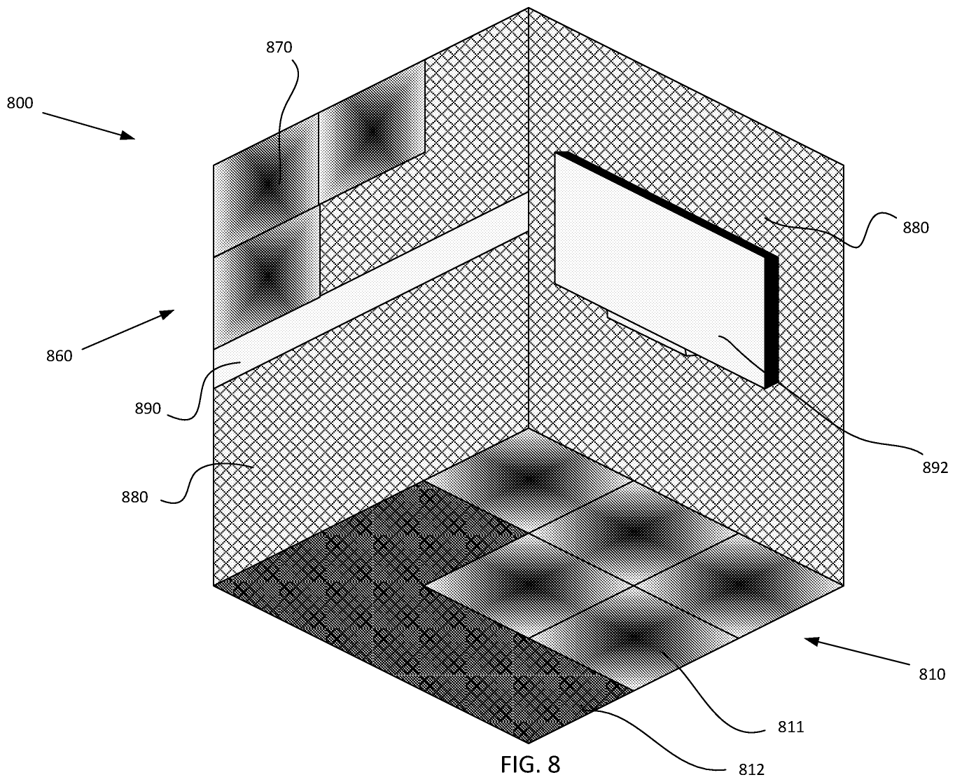

This embodiment comprises the magnetically receptive layer 720 on the surface covering unit 710 and the magnetic underlayment 730 on the supporting surface 750. However, in an alternative embodiment, the surface covering unit 710, whether a wall, floor, or other covering, may have a magnetic layer disposed on the back or reverse side and a magnetically receptive underlayment may be disposed on the supporting surface. For example, when installing the system 700 in an in-ground swimming pool, a magnetically receptive layer may be glued down or otherwise fastened to the base concrete layer of the pool. Magnetic surface covering units may then be quasi-permanently installed on the magnetically receptive underlayment in the pool. Alternatively, a blend of magnetically receptive material may be mixed into a thinset type concrete and spread over the base concrete layer in the pool wherein magnetic surface covering units may then be installed over the magnetically receptive thinset layer. The interchangeable box system 800, described below and as shown in FIG. 8, may also be configured in this alternative manner to suit particular installation applications.

With reference now to FIG. 8, a perspective view of a room having an interchangeable box system 800 is provided. The interchangeable box system 800 combines features of the wall covering system 860 and modular floor covering 810. The magnetic underlayment 880 on the walls is adapted to receive wall covering units 870, trim pieces 890, and may also be adapted to mount additional fixtures such as television 892 either directly or by a frame or other supporting structure affixed to the television and magnetically secured on the underlayment 880. The floor of the interchangeable box system 800 comprises the underlayment 812 and a set of floor covering layers 811. A room implementing the interchangeable box system 800 may have any aspect of the floors or walls changed and redecorated with minimal effort and would not require demolition or tear down of existing decorations or fixtures. To construct a room with the interchangeable box system 800 a support layer 890 would be attached to a wall frame. The magnetic underlayment 880 could be attached to the support layer, the support layer could be impregnated with a magnetic component, a magnetic underlayment 880 could be laminated to the exterior of the support layer 900, or the support layer 890 could be fully coated in a magnetically attractive coating. Wall covering units 870, trim pieces 890, and other fixtures may then be magnetically, semi-permanently, and releaseably secured to the magnetic underlayment 880. The wall covering units 870 may be individual surface covering units or may be a rolled surface covering, such as a paper or vinyl wallpaper, with a magnetically receptive layer disposed on the back of the wall covering unit 870. The underlayment 812 for the modular floor covering 810 may be secured to a supporting surface as described hereinabove. Floor covering units 811 may then be placed on the underlayment 812. Additionally, a magnetic underlayment may be attached to a ceiling in a similar manner to the underlayment 880 on the walls. Ceiling tiles may be secured to the ceiling underlayment in a similar manner to the wall covering units 870.

The magnetic underlayment 880 and underlayment 812 may have the following properties: thickness of 0.060 inches (1.52 mm), hardness of Shore D60, specific gravity of 3.5, a shrinkage 1.5% caused by heating at 158 F for seven days, tensile strength of 700 psi (49 Kg/cm\hat{ }2), and may have parallel poles (north south) along the length at 2.0 mm intervals. The floor covering unit 811 and wall covering unit 600 may have a magnetically isotropic receptive material laminated onto the surface to be placed on the underlayment 812 or magnetic underlayment 880 respectively while the underlayments may either use an anisotropic or isotropically magnetized flexible layer laminated onto or incorporated in the underlayment at the time of manufacture. Specifically, the manufacturing process described in U.S. Published Application US2016/0375673 may be used to manufacture the magnetic underlayment for use in the system. Specifically, the process may use pulse magnetization to isotropically magnetize the underlayment 812 or magnetic underlayment 880. Pulse magnetization utilizes a coil and a set of capacitors to create short “pulse” bursts of energy to slowly increase the magnetic field and to completely penetrate the underlayment 812 or magnetic underlayment 880. The pulse magnetization may also be used to anisotropically magnetize the underlayment 812 or magnetic underlayment 880 if desired.

If the magnetically attractive layer is incorporated into the underlayment 812 or underlayment 880, a dry mixture of strontium ferrite powder and rubber polymer resin (e.g., rubber, PVC, or other like materials to make a thermoplastic binder), is mixed, calendared and ground then formed by a series of rollers to give it the correct width and thickness. The material is then magnetized on one side only.

The magnetic performance of bonded magnets is limited by the amount of polymer used (typically between 20-45% by volume) as this significantly dilutes the remanence of the material. In addition, the melt-spun powder has an isotropic microstructure. The dilution effect is overcome by incorporating an anisotropic magnetic powder. By inducing texture in the magnetic powder or milling it to a fine micrometer-scale particle size, and then preparing the magnet in an aligning field, the bonded magnet can then have an enhanced remanence in a particular direction. The magnetic underlayment, such as underlayment 812 or underlayment 880, is magnetized directionally to give it a stronger remanence. However, the magnetically receptive sheeting is not pole oriented and therefore does not need to be oriented in any one direction. The optimal temperature range for long term durability of the underlayment 812 or underlayment 880 is from 95 C to −40 C.

For an extruded flexible magnet, the flexible granular material is heated until it begins to melt and is then forced under high pressure using a screw feed through a hardened die which has been electrical discharge machine (EDM) wire eroded to have the desired shape of the finished profile. Flexible magnets can be extruded into profiles which can be coiled into rolls and applied or combined. The non-magnetized face of a flexible magnet may be laminated with a double-sided adhesive tape or laminated with a thin vinyl coating so that a printed layer may be applied. An attached cushion may also be applied for flooring purposes. Anisotropic permanent flexible magnets may have a Residual Magnetic Flux Density (Br) of T(G): 0.22 to 0.23 or (2250-2350) and a Holding Power (BHC) of 159 to 174 kA/m or 2000-2180 (i) while Isotropic permanent flexible magnets have a residual magnetic flux density (Br) of 0.14 to 0.15 T or 1400-1550 (G) and a holding power(BHC) of 100 to 111 kA/m or 1250-1400 (Oe). An Anisotropic permanent flexible magnet may be 40% stronger in magnetic remanence then an Isotropic one.

For the floor covering units 811 and wall covering units 870, the magnetically receptive material of the attractant layer or semi-solid compound may have the following properties: a thickness of 0.025 inches (0.64 mm), a hardness of Shore D60, a specific gravity of 3.5, a shrinkage 1.5% caused by heating at 158 F for seven days, tensile strength of 700 psi (49 Kg/cm\hat{ }2), and a hold strength of 140 grams/cm\hat{ }2.

In the interchangeable box system 800 all components are “quasi” permanently secured to the underlayment. Due to the immense surface area the magnetic resonance between the underlayment 812 or underlayment 880 and the floor covering unit 811 or wall covering unit 870, the materials have an extremely strong bond, making the installation “quasi” permanent. However, the bond may be broken by “catching” a corner and prying upwards to break the bond, thereby allowing the floor covering unit 811 or wall covering unit 870 to be changed on demand, something currently unavailable with any existing technology. In the interchangeable box system 800, any building material with a flat backing (for optimal magnetic remanence) can be utilized in this system. A floor covering unit 811 made from wood, for example, may also be utilized as a wall covering unit 870 or vice versa.

The ability to remove any piece at any given time during the construction process is highly desirable. If a wall panel 870 in the interchangeable box system 870 does not match correctly or needs to be trimmed, as may be the case in many installations, one can simply remove a wall piece 870 and reattach on demand with no abatement.

In the Flooring industry, the prevailing method of seaming a rolled carpet requires affixing a tack strip on the perimeter of the room, hot melt taping the seams and stretching or “tensioning” the rolled floor covering to keep the product in place. This allows for product failure by the actual carpet delaminating due to tension (primary backing of the flooring pulling away from the secondary backing), heat distortion of the finished goods, peaking of the seam, etc. There are many ways that the conventional method can fail. The system 800 eliminates these failures and eliminates the need for tackstrip, as the floor covering unit 811 no longer has to be tensioned. Magnetic remanence due to immense surface area, prevents the floor covering unit 811 from “peaking” or moving under stress.

In the event that an existing wall or a new construction wall has a defect; such as a bow or concave limiting magnetic remanence, one could simply use a double sided magnetically receptive and magnetic backed shim to alleviate the problem as an accessory to the interchangeable box system. The floor covering units 811 and wall covering units 870 can provide different designs, logos, textures, colors, acoustic properties, reflective properties, or design elements in a room. The floor covering units 810 and wall covering units 870 may also incorporate corporate or other branding or sponsorship information and may be used for advertising or as signage. Homeowners, business owners, or designers may change out any aspect of any room using the interchangeable box system 800 on demand at any time.

The flexible nature of the interchangeable box system 800 would also provide benefits in the film, television, and theatre industries. In these industries, TV sets, movie sets and the like are built in a modular fashion and typically emulate a real location in a more cost-effective manner. Unfortunately, these sets are built for their specific use on a frame and then that frame must be stored for another “like” use of the same set or a new set must be built each and every time to suit the scene. With the interchangeable box system 800, it would be highly cost effective and highly beneficial to change the scene of a room on demand utilizing the same frames. It is also cost effective in large studios that must have a western town set for a first scene and then a New York City set for another scene. The ability to use the same frames but change the wall coverings 870 and floor covering units 810 to simulate what is needed would be desirable and cost effective.

While the invention has been described by reference to certain preferred embodiments, it should be understood that numerous changes could be made within the spirit and scope of the inventive concept described. Also, the present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

What is claimed is:

1) A surface covering system, the system when installed providing a removably-fixed surface covering, the system comprising:
a magnetic surface covering unit comprising a non-magnetized, isotropic magnetic receptive layer; and
an anisotropically magnetized underlayment disposed on a supporting surface;
wherein the magnetic surface covering unit is adapted to be magnetically attracted to and received opposite the anisotropically magnetized underlayment in a fixed installation and to be non-destructively removable from the anisotropically magnetized underlayment subsequent to fixed installation.

2) The system of claim 1, wherein the anisotropically magnetized underlayment is 0.5 mm in thickness and comprises magnetizable material having a Mesh size configured to have, when magnetized, enhanced magnetic attraction property and adapted for supporting the magnetic surface covering unit in a non-horizontal fixed installation, wherein the non-horizontal fixed installation is one of an interior wall installation, an exterior wall installation, an airplane interior cabin installation, an exterior roof installation, or an interior ceiling installation.

3) The system of claim 1, wherein the anisotropically magnetized underlayment comprises:
a magnetizable material including an iron powder;
a binder component; and
an oil having properties allowing for rapid setting during manufacturing, whereby setting occurs at a normal line speed in a calendaring or extrusion process.

4) The system of claim 3, wherein the magnetizable material comprises one of: ferrous iron powder, strontium ferrite powder, neodymium powder, and a neodymium and ferrous iron powder composite.

5) The system of claim 3, wherein the binder comprises thermoplastic chlorinated polyethylene elastomer (“CPE”).

6) The system of claim 3, wherein the oil comprises epoxidized soybean oil (“ESBO”).

7) The system of claim 1, wherein the anisotropically magnetized underlayment is one of a calendared sheet good or an extruded sheet good.

8) The system of claim 1, wherein the anisotropically magnetized underlayment comprises a magnetizable material having a Mesh size of 1-2.3 μm.

9) A magnetized underlayment for securing magnetically-receptive surface covering units on a supporting surface, the magnetized underlayment comprising:
a neodymium powder;
a binder; and
an oil having properties allowing for rapid setting during manufacturing, whereby setting occurs at a normal line speed in a calendaring or extrusion process.

10) The magnetized underlayment of claim 9 further comprises a plasticizer.

11) The magnetized underlayment of claim 9, wherein the oil comprises epoxidized soybean oil (“ESBO”).

12) The magnetized underlayment of claim 9, wherein the ratio of the neodymium powder to the binder and the oil is selected based upon application considerations to be one of: about 91% neodymium powder to about 9% binder and oil; about 81% neodymium powder to about 19% binder and oil; about 71% neodymium powder to about 29% binder and oil; about 61% neodymium powder to about 39% binder and oil; or about 51% neodymium powder to about 49% binder and oil.

13) The magnetized underlayment of claim 9, wherein the magnetic underlayment layer further comprises a ferrite powder.

14) The magnetized underlayment of claim 13, wherein the ratio of the ferrite powder to the neodymium powder is 50/50.

15) A method for applying a magnetically receptive layer on a surface covering unit to produce a magnetically receptive surface covering unit adapted to be magnetically secured opposite a magnetized underlayment, the method comprising:
adding a receptive material blend and an oil compound in a mixer;
blending the receptive material blend and the oil compound to form a magnetically receptive oil blend;
spraying the magnetically receptive oil blend onto a surface covering unit; and
setting the magnetically receptive oil blend onto the surface covering unit.

16) The method of claim 15, wherein the receptive material blend comprises one of:
ferrous iron powder, strontium ferrite powder, and neodymium powder, and neodymium and ferrous iron powder composite.

17) The method of claim 15, wherein the oil compound comprises one of: ultraviolet (“UV”) oil, and polyvinyl chloride (“PVC”) resin.

18) The method of claim 15, wherein the setting of the magnetically receptive oil blend comprises rapidly setting the magnetically receptive oil blend by high intensity ultraviolet (“UV”) lights.

19) The method of claim 15, wherein the setting of the magnetically receptive oil blend comprises setting the magnetically receptive oil blend by high temperature.
